(19) United States
(12) Patent Application Publication
(10) Pub. No.: US 2026/0082375 A1
(43) Pub. Date: Mar. 19, 2026

(54) INFORMATION TRANSMISSION METHOD, RESOURCE DETERMINATION METHOD, RESOURCE SELECTION METHOD, DEVICE, AND STORAGE MEDIUM

(71) Applicant: ZTE CORPORATION, Shenzhen (CN)

(72) Inventors: Haigang HE, Shenzhen (CN); Youxiong LU, Shenzhen (CN); Weimin XING, Shenzhen (CN); Feng BI, Shenzhen (CN); Jie CHEN, Shenzhen (CN)

(21) Appl. No.: 19/123,588

(22) PCT Filed: Feb. 5, 2024
(86) PCT No.: PCT/CN2024/075905

§ 371 Date: Apr. 23, 2025

(30) Foreign Application Priority Data
Feb. 14, 2023 (CN) 202310163809.5

(51) Int. Cl. H04W 72/0453

(52) U.S. Cl. CPC H04W 72/0453

(57) ABSTRACT

Provided are an information transmission method, a resource determination method, a resource selection method, a device, and a storage medium. The information transmission method applied by a first communication entity includes: sending request information to a second communication entity, where the request information is used for requesting the second communication entity to determine a resource set; and sending assistance information for determining the resource set to the second communication entity, where the assistance information includes at least one resource mapping mode, and the resource mapping mode at least includes one of the following: first frequency domain units to which a resource is mapped or the number of first frequency domain units to which a resource is mapped.

### TECHNICAL FIELD

The present application relates to the field of communications, for example, an information transmission method, a resource determination method, a resource selection method, a device, and a storage medium.

### BACKGROUND

The design of a contention-based resource selection scheme for sidelink (SL) communication only considers the spectrum of the intelligent transport system (ITS) and the licensed spectrum allocated to network operators and does not consider the design for the unlicensed spectrum. In particular, one resource pool includes multiple channels for listen before talk (LBT) contention. Therefore, how to provide a contention-based resource selection mechanism in a sidelink scenario is an urgent problem to be solved.

### SUMMARY

In view of the above, embodiments of the present application provide an information transmission method, a resource determination method, a resource selection method, a device, and a storage medium to implement the contention-based resource selection mechanism for the unlicensed spectrum in a sidelink scenario.

An embodiment of the present application provides an information transmission method. The method is applied by a first communication entity and includes the following operations.

Request information is sent to a second communication entity, where the request information is used for requesting the second communication entity to determine a resource set. Assistance information for determining the resource set is sent to the second communication entity, where the assistance information includes at least one resource mapping mode, and the resource mapping mode at least includes one of the following: first frequency domain units to which a resource is mapped or the number of first frequency domain units to which a resource is mapped.

An embodiment of the present application provides a resource determination method. The resource determination method is applied by a second communication entity and includes the following operations.

Request information sent by a first communication entity is received, where the request information is used for requesting the second communication entity to determine a resource set. Assistance information for determining the resource set is acquired. The resource set is determined based on the assistance information. The determined resource set is reported to the first communication entity to cause the first communication entity to select at least one resource from the resource set for sending communication information, where the assistance information includes at least one resource mapping mode, and the resource mapping mode at least includes one of the following: first frequency domain units to which a resource is mapped or the number of first frequency domain units to which a resource is mapped.

An embodiment of the present application provides a resource selection method. The resource selection method is applied by the first communication entity and includes the following operations.

A resource set reported by a second communication entity is received, where each resource in the resource set includes L second frequency domain units. At least one resource is selected from the resource set to cause a user equipment corresponding to the first communication entity to send communication information using the selected at least one resource.

An embodiment of the present application provides a communication entity. The communication entity includes a memory and one or more processors. The memory is configured to store one or more programs. When the one or more programs are executed by the one or more processors, the one or more processors are caused to implement the method in any of the preceding embodiments.

An embodiment of the present application provides a storage medium storing a computer program which, when executed by a processor, causes the processor to implement the method in any of the preceding embodiments.

### BRIEF DESCRIPTION OF DRAWINGS

FIG. 1 is a flowchart of an information transmission method according to an embodiment of the present application;

FIG. 2 is a flowchart of a resource determination method according to an embodiment of the present application;

FIG. 3 is a flowchart of a resource selection method according to an embodiment of the present application;

FIG. 4 is a schematic diagram of the configuration of a first resource set and a second resource set according to an embodiment of the present application;

FIG. 5 is a schematic diagram of the mapping of one resource to first frequency domain units in one resource mapping mode according to an embodiment of the present application;

FIG. 6 is a schematic diagram of the mapping of another resource to first frequency domain units in one resource mapping mode according to an embodiment of the present application;

FIG. 7 is a schematic diagram of the mapping of one resource to first frequency domain units in another resource mapping mode according to an embodiment of the present application;

FIG. 8 is a schematic diagram of the mapping of another resource to first frequency domain units in another resource mapping mode according to an embodiment of the present application;

FIG. 9 is a schematic diagram of the mapping of yet another resource to first frequency domain units in another resource mapping mode according to an embodiment of the present application;

FIG. 10 is a schematic diagram of the mapping of one resource to first frequency domain units in yet another resource mapping mode according to an embodiment of the present application;

FIG. 11 is a schematic diagram of the mapping of another resource to first frequency domain units in yet another resource mapping mode according to an embodiment of the present application;

FIG. 12 is a schematic diagram of the interaction between a first communication entity and a second communication entity according to an embodiment of the present application;

FIG. 13 is a schematic diagram of the communication of the first communication entity according to an embodiment of the present application;

FIG. 14 is a schematic diagram of the communication of the second communication entity according to an embodiment of the present application;

FIG. 15 is a schematic diagram of another communication of the first communication entity according to an embodiment of the present application;

FIG. 16 is a schematic diagram of another communication of the second communication entity according to an embodiment of the present application;

FIG. 17 is a schematic diagram of the configuration of first frequency domain units and second frequency domain units according to an embodiment of the present application;

FIG. 18 is a schematic diagram of the RSRP measurement of one resource according to an embodiment of the present application;

FIG. 19 is a schematic diagram of yet another communication of the second communication entity according to an embodiment of the present application;

FIG. 20 is a schematic diagram of the determination of a resource set according to an embodiment of the present application;

FIG. 21 is a block diagram of an information transmission apparatus according to an embodiment of the present application;

FIG. 22 is a block diagram of a resource determination apparatus according to an embodiment of the present application;

FIG. 23 is a block diagram of a resource selection apparatus according to an embodiment of the present application; and

FIG. 24 is a structure diagram of a communication entity according to an embodiment of the present application.

### DETAILED DESCRIPTION

Embodiments of the present application are described hereinafter in conjunction with drawings. The present application is described hereinafter in conjunction with embodiments and drawings. The examples illustrated are intended to explain the present application.

In a sidelink communication system, in the case where traffic needs to be transmitted between user equipments (UEs), the traffic to be transmitted between UEs is not forwarded by a network side, that is, the traffic is not forwarded through cellular links between the UEs and a base station but is directly transmitted from a data source UE to a target UE through a sidelink. Such a direct communication mode between UEs is significantly different from the conventional communication mode of a cellular system. The typical applications of sidelink communication include device-to-device (D2D) communication and vehicle-to-everything (V2X) communication. The V2X communication includes vehicle-to-vehicle (V2V), vehicle-to-pedestrian (V2P), and vehicle-to-infrastructure (V2I). For the users who can apply sidelink communication to perform near-field communication, in addition to saving wireless spectrum resources, sidelink communication can also reduce the transmission pressure of a core network, reduce the occupation of system resources, and increase the spectral efficiency of a cellular communication system, thereby reducing the communication delay and greatly lowering network operation costs.

In sidelink communication, a sending device selects a resource for signaling/data sending. One method of selecting a resource is a contention-based resource selection method. In the contention-based resource selection method, the device listens to resources within a resource pool to acquire the occupation situations of the resources and autonomously selects a resource for sending signaling or data from the resource pool according to the listening result. The contention-based resource selection method may also be called the terminal autonomous resource selection method.

Transmission can be performed only on a channel with an LBT success in the unlicensed spectrum. The “LBT” means that a communication node needs to contend for resources and only when the contention for time-frequency resources succeeds can the communication node transmit information on the time-frequency resources. In the LBT mechanism, the communication node performs a channel access procedure (to listen to whether a channel is idle) before information transmission, and the communication node can transmit information only when the listened channel is idle. Since the LBT mechanism described above serves as a typical channel access mechanism, a terminal may perform a channel access procedure such as the LBT, and after determining the listened channel to be idle, occupy the channel.

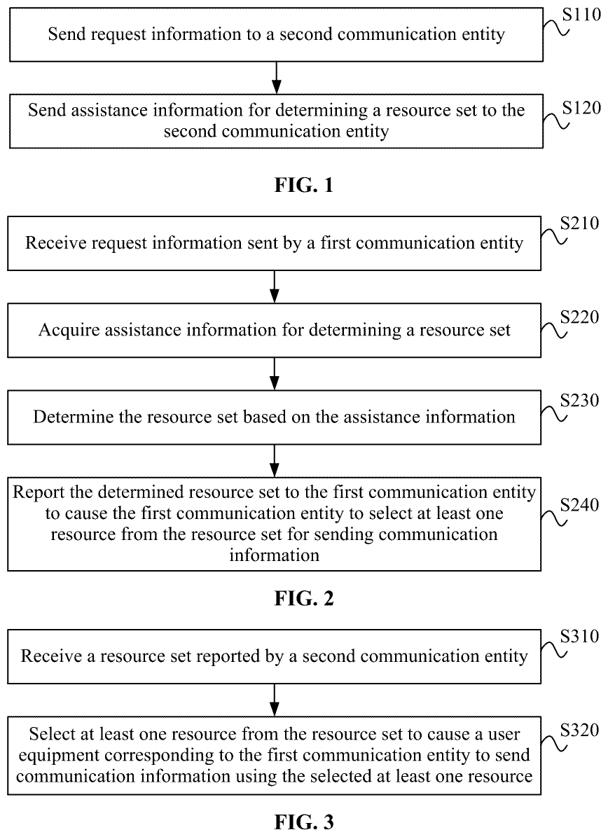

In an embodiment, FIG. 1 is a flowchart of an information transmission method according to an embodiment of the present application. This embodiment is applied to the case of contention-based resource selection in a sidelink scenario. This embodiment may be executed by a first communication entity. For example, the first communication entity may include, but is not limited to, a media access control (MAC) layer of a first UE, the first UE, and a sidelink module 1 of the first UE. As shown in FIG. 1, this embodiment includes S110 and S120.

In S110, request information is sent to a second communication entity.

The request information is used for requesting the second communication entity to determine a resource set. For example, the second communication entity may include, but is not limited to, a physical layer of the first UE, a second UE, and a sidelink module 2 of the first UE.

In S120, assistance information for determining the resource set is sent to the second communication entity.

The assistance information includes at least one resource mapping mode, and the resource mapping mode at least includes one of the following: first frequency domain units to which a resource is mapped or the number of first frequency domain units to which a resource is mapped. In this embodiment, the first communication entity may request the second communication entity to determine a resource set. After the second communication entity receives the request information sent by the first communication entity, the second communication entity determines the resource set based on the assistance information sent by the first communication entity for determining the resource set. In this embodiment, the assistance information may include one resource mapping mode or the assistance information may include one resource mapping mode list that includes multiple resource mapping modes. Each resource mapping mode includes at least one of the following: first frequency domain units to which a resource is mapped or the number of first frequency domain units to which a resource is mapped.

In an embodiment, the assistance information further includes the number of second frequency domain units to which the resource is mapped. In this embodiment, the assistance information may include the number of second frequency domain units to which one resource is mapped.

In an embodiment, the first frequency domain unit includes one of the following: a resource block set or one frequency domain unit including a first preset bandwidth, and the second frequency domain unit includes one of the following: a sub-channel or an interleave. In this embodiment, the resource set may also be referred to as an RB set. The RB set may be multiple resource blocks (RBs) included in one frequency domain unit of a first preset bandwidth, for example, multiple consecutive RBs. The first preset bandwidth is related to the unit of unlicensed spectrum channel contention. For example, the first preset bandwidth may be 20 MHz. Each first frequency domain unit may include several sub-channels and/or several interleaves. One interleave may include several RBs that are discrete in the frequency domain. One sub-channel may include several RBs, or one sub-channel may include several interleaves.

In an embodiment, one resource corresponding to the resource mapping mode is mapped to L second frequency domain units and K first frequency domain units, where K is a positive divisor of L. In this embodiment, the number of second frequency domain units to which one resource corresponding to the resource mapping mode is mapped and the number of first frequency domain units to which one resource corresponding to the resource mapping mode is mapped may be understood as the number of second frequency domain units included in one resource corresponding to the resource mapping mode and the number of first frequency domain units included in one resource corresponding to the resource mapping mode, respectively. In this embodiment, “one resource corresponding to the resource mapping mode is mapped to L second frequency domain units” may be understood as that one resource corresponding to the resource mapping mode includes L second frequency domain units, and “one resource corresponding to the resource mapping mode is mapped to K first frequency domain units” may be understood as that one resource corresponding to the resource mapping mode includes K first frequency domain units. In this embodiment, in any resource mapping mode, the number of first frequency domain units to which one resource is mapped is divisible by the number of second frequency domain units to which one resource is mapped.

In an embodiment, the operation where one resource corresponding to the resource mapping mode is mapped to L second frequency domain units and K first frequency domain units includes at least one of the following operations.

In different resource mapping modes, the number of first frequency domain units to which one resource is mapped is different; one resource is mapped to K first frequency domain units, where each first frequency domain unit includes L/K second frequency domain units to which the resource is mapped, and L/K is a positive integer; one resource is mapped to K first frequency domain units, where the starting location of each of K first second frequency domain units to which one resource is mapped in the K first frequency domain units are the same; or one resource is mapped to K consecutive first frequency domain units.

In this embodiment, in different resource mapping modes, the number of second frequency domain units included in one resource may be the same, but the number of first frequency domain units to which one resource is mapped is different. In any resource mapping mode, one resource is mapped to K first frequency domain units, and the resource is mapped to L/K second frequency domain units in each first frequency domain unit. In this embodiment, K first second frequency domain units to which one resource is mapped in the K first frequency domain units refer to the first second frequency domain unit to which one resource is mapped included in each of the K first frequency domain units. In one resource mapping mode, one resource is mapped to K first frequency domain units, and the starting locations of the first second frequency domain units occupied by the resource in different first frequency domain units are the same, that is, the frequency domain locations of first resources occupied by the resource in different first frequency domain units are the same.

In an embodiment, FIG. 2 is a flowchart of a resource determination method according to an embodiment of the present application. This embodiment is applied to the case of contention-based resource selection in a sidelink scenario. This embodiment may be executed by a second communication entity. As shown in FIG. 2, this embodiment includes S210 to S240.

In S210, request information sent by a first communication entity is received.

The request information is used for requesting the second communication entity to determine a resource set.

In S220, assistance information for determining the resource set is acquired.

In S230, the resource set is determined based on the assistance information.

In S240, the determined resource set is reported to the first communication entity to cause the first communication entity to select at least one resource from the resource set for sending communication information.

The assistance information includes at least one resource mapping mode, and the resource mapping mode at least includes one of the following: first frequency domain units to which a resource is mapped or the number of first frequency domain units to which a resource is mapped.

In this embodiment, the first communication entity requests the second communication entity to determine a resource set, and the second communication entity receives the request information sent by the first communication entity, acquires assistance information for determining the resource set, determines the resource set based on the assistance information, and reports the determined resource set to the first communication entity to cause the first communication entity to select a resource from the determined resource set so that other communication entities or the first communication entity sends communication information on the selected resource. In an embodiment, in the case where the first communication entity is a first UE and the second communication entity is a second UE, after the first UE receives a resource set determined by the second UE, the first UE selects at least one resource from the resource set and sends communication information. In an embodiment, in a case where the first communication entity is the MAC layer of the first UE and the second communication entity is the physical layer of the first UE, after the MAC layer of the first UE receives a resource set determined by the physical layer of the first UE, the MAC layer of the first UE selects at least one resource from the resource set and notifies the physical layer of the first UE of the selected resource to cause the physical layer of the first UE to send communication information on the selected resource.

In an embodiment, the operation where the assistance information for determining the resource set is acquired includes the following operation: a resource mapping mode corresponding to one resource pool including Y first frequency domain units is determined based on a preset rule. The preset rule includes the following: the number M of resource mapping modes corresponding to one resource pool is less than or equal to Y and is a positive divisor of L; and for an m-th resource mapping mode, one resource is mapped to Zₘ RB sets in the resource pool, where Zₘ is a positive divisor of L, m is a positive integer less than or equal to m, and values of Zₘ corresponding to different values of m are different.

In this embodiment, the second communication entity may determine the assistance information based on the preset rule. In this embodiment, one resource pool includes Y first frequency domain units, and the assistance information includes a resource mapping mode corresponding to one resource pool. Accordingly, the second communication entity determines a resource mapping mode of each resource including L second frequency domain units in the resource pool based on the preset rule. In this embodiment, the M resource mapping modes may be labeled as a first resource mapping mode, a second resource mapping mode, . . . , and an M-th resource mapping mode. In the first resource mapping mode, one resource is mapped to Z₁ RB sets in the resource pool; in the second resource mapping mode, one resource is mapped to Z₂ RB sets in the resource pool; . . . ; and in the M-th resource mapping mode, one resource is mapped to Z_{M} RB sets in the resource pool.

In an embodiment, the operation where the assistance information for determining the resource set is acquired includes the following operation.

Assistance information sent by the first communication entity or a third communication entity for determining the resource set is received. In this embodiment, the second communication entity may receive the assistance information sent by the first communication entity or the third communication entity and determine the resource set based on the assistance information. For example, the third communication entity may include, but is not limited to, a base station and a radio resource control (RRC) layer of the first UE.

In an embodiment, the first frequency domain unit includes one of the following: an RB set or one frequency domain unit including a first preset bandwidth, and the second frequency domain unit to which one resource is mapped includes one of the following: a sub-channel or an interleave.

In an embodiment, each candidate resource in a first resource set includes L second frequency domain units, and the first resource set includes N second resource sets. The operation where the resource set is determined based on the assistance information includes one of the following operations: resource exclusion is performed on the first resource set to determine one resource set or resource exclusion is separately performed on the N second resource sets to determine N resource sets, where one second resource set corresponds to one resource mapping mode, and in different resource mapping modes, the number of first frequency domain units to which one resource is mapped is different. In this embodiment, the second communication entity may directly perform resource exclusion on the first resource set and take the remaining resources as one determined resource set. The second communication entity may also divide the first resource set into N second resource sets, perform resource exclusion on each second resource set, and take the remaining resources in each second resource set as a corresponding resource set to obtain N determined resource sets.

In an embodiment, the operation where resource exclusion is performed on the first resource set to determine one resource set includes the following operation.

Resource exclusion is performed on the first resource set to determine one third resource set, where the third resource set includes N1 fourth resource sets. Accordingly, the operation where the determined resource set is reported to the first communication entity includes the following operation: the determined third resource set is reported to the first communication entity, where one fourth resource set corresponds to one resource mapping mode, and in different resource mapping modes, the number of first frequency domain units to which one resource is mapped is different. In this embodiment, the second communication entity performs reference signal received power (RSRP) measurement on each resource in the first resource set, performs resource exclusion on the first resource set based on the RSRP measurement result, and takes the remaining resources after resource exclusion as one third resource set. The second communication entity divides the third resource set to obtain N1 fourth resource sets, where N1 is a positive integer greater than 1. In this embodiment, one fourth resource set corresponds to one resource mapping mode, and in different resource mapping modes, the number of first frequency domain units to which one resource is mapped is different.

In an embodiment, the operation where resource exclusion is separately performed on the N second resource sets to determine N resource sets includes the following operation: resource exclusion is separately performed on each of the N second resource sets to determine one fifth resource set for each resource set. Accordingly, the operation where the determined resource set is reported to the first communication entity includes the following operation: the determined N fifth resource sets are reported to the first communication entity, where one fifth resource set corresponds to one resource mapping mode, and in different resource mapping modes, the number of first frequency domain units to which one resource is mapped is different. In this embodiment, in the case where the first resource set includes N second resource sets, the second communication entity may perform RSRP measurement on each resource in each second resource set, perform resource exclusion on each second resource set based on the RSRP measurement result, determine a corresponding fifth resource set for each second resource set, and then report the N fifth resource sets to the first communication entity. In this embodiment, one fifth resource set corresponds to one resource mapping mode, and in different resource mapping modes, the number of first frequency domain units to which one resource is mapped is different.

In an embodiment, the assistance information includes at least one resource mapping mode, and the operation where the resource set is determined based on the assistance information at least includes one of the following operations.

A first resource set and a second resource set are determined based on the resource mapping mode. A first resource set is determined based on the resource mapping mode. A second resource set is determined based on the resource mapping mode. In this embodiment, the second communication entity may determine a second resource set based on the resource mapping mode, may directly determine a first resource set based on the resource mapping mode, or may determine a first resource set and a second resource set included in the first resource set based on the resource mapping mode.

In an embodiment, the resource determination method applied by the second communication entity further includes the following operation: first signaling information is sent to the first communication entity, where the first signaling information is used for indicating a resource mapping mode corresponding to each of the N fifth resource sets. In this embodiment, the second communication entity reports N fifth resource sets and a resource mapping mode corresponding to each fifth resource set to the first communication entity to cause the first communication entity to determine the number of first frequency domain units to which a corresponding fifth resource set is mapped according to the resource mapping mode.

In an embodiment, the resource determination method applied by the second communication entity further includes the following operation: second signaling information is sent to the first communication entity, where the second signaling information is used for indicating a resource mapping mode corresponding to each resource in each third resource set. In this embodiment, the second communication entity may report a third resource set and a resource mapping mode of each resource in the third resource set to the first communication entity, where the resource mapping mode includes the number of first frequency domain units to which one resource is mapped, and in different resource mapping modes, the number of first frequency domain units to which one resource is mapped is different.

In an embodiment, the third resource set includes several resources. The operation where the determined third resource set is reported to the first communication entity includes the following operations: the several resources are sorted according to the number of first frequency domain units corresponding to a resource mapping mode, and the sorted third resource set is reported to the first communication entity. In this embodiment, after resource exclusion is performed on the first resource set, one corresponding third resource set is obtained. The third resource set includes several resources. The second communication entity may sort the several resources included in the third resource set according to the number of first frequency domain units corresponding to the resource mapping mode and report the sorted third resource set to the first communication entity. For example, it is assumed that the third resource set includes three fourth resource sets, which are a first fourth resource set, a second fourth resource set, and a third fourth resource set, and the first fourth resource set, the second fourth resource set, and the third fourth resource set correspond to a resource mapping mode 1, a resource mapping mode 2, and a resource mapping mode 3, respectively. The second communication entity sorts the three fourth resource sets in the third resource set according to the resource mapping modes and reports the sorted third resource set to the first communication entity.

In an embodiment, the resource determination method applied by the second communication entity further includes the following operation: third signaling information is sent to the first communication entity, where the third signaling information includes the determined N fifth resource sets. The operation where the third signaling information is sent to the first communication entity includes the following operations: the N fifth resource sets in the third signaling information are sorted according to the number of first frequency domain units corresponding to a resource mapping mode, and the sorted third signaling information is reported to the first communication entity. In this embodiment, the second communication entity sorts the N fifth resource sets according to the number of first frequency domain units corresponding to the resource mapping mode, sequentially carries the N fifth resource sets to the third signaling information according to the sorting result, and reports the sorted third signaling information to the first communication entity.

In an embodiment, the operation where the several resources are sorted according to the number of first frequency domain units corresponding to the resource mapping mode includes one of the following operations.

The several resources are sorted according to the number of first frequency domain units corresponding to the resource mapping mode in ascending order. The several resources are sorted according to the number of first frequency domain units corresponding to the resource mapping mode in descending order. In this embodiment, the second communication entity may sort the several resources included in the third resource set according to the number of first frequency domain units corresponding to the resource mapping mode in ascending order or may sort the several resources included in the third resource set according to the number of first frequency domain units corresponding to the resource mapping mode in descending order.

In an embodiment, the operation where the N fifth resource sets are sorted according to the number of first frequency domain units corresponding to the resource mapping mode includes one of the following operations.

The N fifth resource sets are sorted according to the number of first frequency domain units corresponding to the resource mapping mode in ascending order. The N fifth resource sets are sorted according to the number of first frequency domain units corresponding to the resource mapping mode in descending order. In this embodiment, the second communication entity may sort the N fifth resource sets according to the number of first frequency domain units corresponding to the resource mapping mode in ascending order or may sort the N fifth resource sets according to the number of first frequency domain units corresponding to the resource mapping mode in descending order.

In an embodiment, the resource determination method applied by the second communication entity further includes the following operations.

A radio resource control (RRC) message sent by a third communication entity is received, where the RRC message includes proportional value configuration information corresponding to each of the N second resource sets, and the proportional value corresponding to a second resource set i is labeled as Xᵢ; and an RSRP threshold value Tᵢ corresponding to the second resource set i is determined, where the RSRP threshold value Tᵢ meets the condition that the value of Nᵢ is greater than or equal to the product value of Xᵢ and Mᵢ. Accordingly, the operation where resource exclusion is separately performed on the N second resource sets includes the following operation: resource exclusion is separately performed on the N second resource sets based on an RSRP threshold value Tᵢ corresponding to each of the N second resource sets, where Nᵢ is the number of remaining resources after resource exclusion is performed on the second resource set i, Mᵢ is the total number of resources included in the second resource set i, and i is a positive integer greater than or equal to 1 and less than or equal to N.

In this embodiment, the second communication entity receives the RRC message sent by the third communication entity and separately performs resource exclusion on the N second resource sets according to the proportional value configuration information corresponding to each of the N second resource sets in the RRC message. Before the second communication entity performs resource exclusion on any one of the second resource sets, the second communication entity determines the RSRP threshold value corresponding to the second resource set to enable the RSRP threshold value to meet the condition that the value of Nᵢ is greater than or equal to the product value of Xᵢ and Mᵢ.

In an embodiment, the RRC message further includes the relationship between a channel busy ratio (CBR) range and the proportional value Xᵢ, and the relationship between the CBR range and the proportional value Xᵢ is used for determining the proportional value Xᵢ corresponding to each of the N second resource sets. In this embodiment, the second communication entity may receive the RRC message sent by the third communication entity, and the relationship between the CBR range and the proportional value Xᵢ is included in the RRC message. The CBR range is a proportion of resources whose energy values measured by the second communication entity exceed a threshold value. For example, the CBR may be the proportion of resources whose energy values measured by the second communication entity exceed a threshold value in one resource pool.

In an embodiment, FIG. 3 is a flowchart of a resource selection method according to an embodiment of the present application. This embodiment is applied to the case of contention-based resource selection in a sidelink scenario. This embodiment may be executed by a first communication entity. As shown in FIG. 3, this embodiment includes S310 and S320.

In S310, a resource set reported by a second communication entity is received.

Each resource in the resource set includes L second frequency domain units.

In S320, at least one resource is selected from the resource set to cause a user equipment corresponding to the first communication entity to send communication information using the selected at least one resource.

In this embodiment, the first communication entity receives the resource set reported by the second communication entity and selects at least one resource from the resource set to cause the first communication entity or a UE corresponding to the first communication entity to send communication information using the selected at least one resource.

In an embodiment, the operation where the resource set reported by the second communication entity is received includes the following operation.

One third resource set reported by the second communication entity is received, where the third resource set includes N1 fourth resource sets, one fourth resource set corresponds to one resource mapping mode, and in different resource mapping modes, the number of first frequency domain units to which one resource is mapped is different.

In an embodiment, the operation where the resource set reported by the second communication entity is received includes the following operation.

N fifth resource sets reported by the second communication entity are received, where one fifth resource set corresponds to one resource mapping mode, and in different resource mapping modes, the number of first frequency domain units to which one resource is mapped is different.

In an embodiment, the operation where the at least one resource is selected from the resource set includes one of the following: the resource is preferentially selected from a fourth resource set having a small number of first frequency domain units; the resource is preferentially selected from a fourth resource set having a large number of first frequency domain units; the resource is preferentially selected from a fifth resource set having a small number of first frequency domain units; or the resource is preferentially selected from a fifth resource set having a large number of first frequency domain units.

In an embodiment, the resource selection method applied by the first communication entity further includes the following operation.

First signaling information is received, where the first signaling information is used for indicating a resource mapping mode corresponding to each fifth resource set.

In an embodiment, the resource selection method applied by the first communication entity further includes the following operation: second signaling information is received, where the second signaling information is used for indicating a resource mapping mode corresponding to each resource in each third resource set.

In an embodiment, the operation where one third resource set reported by the second communication entity is received includes the following operation.

A third resource set that is sorted according to the number of first frequency domain units corresponding to a resource mapping mode and reported by the second communication entity is received.

In an embodiment, the operation where N fifth resource sets reported by the second communication entity are received includes the following operation.

N fifth resource sets that are sorted according to the number of first frequency domain units corresponding to a resource mapping mode and reported by the second communication entity are received.

In an embodiment, the operation where sorting is performed according to the number of first frequency domain units corresponding to the resource mapping mode includes one of the following operations.

In the third resource set, sorting is performed according to the number of first frequency domain units corresponding to the resource mapping mode in ascending order; in the third resource set, sorting is performed according to the number of first frequency domain units corresponding to the resource mapping mode in descending order; in the N fifth resource sets, sorting is performed according to the number of first frequency domain units corresponding to the resource mapping mode in ascending order; or in the N fifth resource sets, sorting is performed according to the number of first frequency domain units corresponding to the resource mapping mode in descending order.

For explanations and relationships of the resource mapping mode, the first resource set, the second resource set, the third resource set, the fourth resource set, the fifth resource set, the first signaling information, the second signaling information, and other parameters involved in the resource selection method applied by the first communication entity, see the description of the corresponding parameters and relationships in the resource determination method applied by the second communication entity. The details are not repeated here.

In the following embodiments, the process of reporting assistance information, the process of determining a resource set, and the process of selecting a resource are described below through different embodiments.

### Embodiment One

In an embodiment, the first resource set includes N second resource sets. One second resource set corresponds to one resource mapping mode. In different resource mapping modes, the number of first frequency domain units to which one resource is mapped is different.

In this embodiment, the first frequency domain unit may be an RB set or the first frequency domain unit may be a frequency domain unit including a bandwidth of 20 MHz. The RB set may be several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

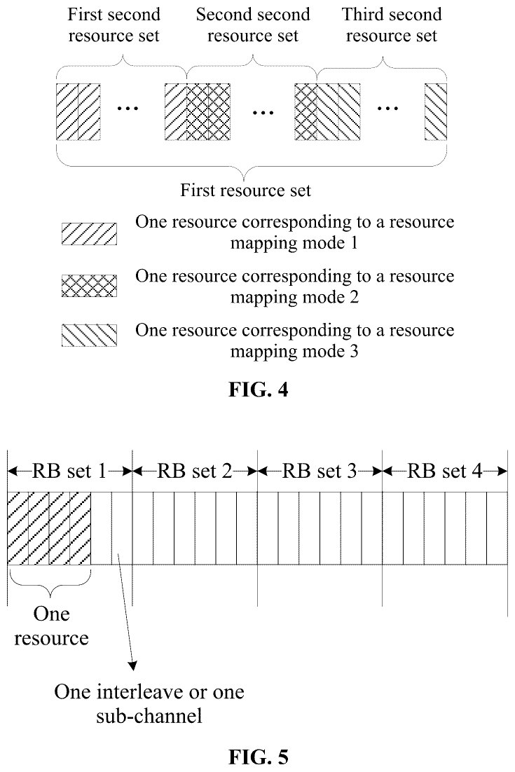

FIG. 4 is a schematic diagram of the configuration of a first resource set and a second resource set according to an embodiment of the present application. As shown in FIG. 4, the first resource set includes N=3 second resource sets, and these three second resource sets are labeled as a first second resource set, a second second resource set, and a third second resource set, respectively. The first second resource set, the second second resource set, and the third second resource set include 12 resources, 15 resources, and 6 resources, respectively. At this point, the first resource set includes a total of 33 resources. Each resource in the first resource set includes L sub-channels.

One second resource set corresponds to one resource mapping mode. The resource mapping modes corresponding to the first second resource set, the second second resource set, and the third second resource set are labeled as a resource mapping mode 1, a resource mapping mode 2, and a resource mapping mode 3, respectively.

In different resource mapping modes, the number L of sub-channels included in one resource is the same, but the number of RB sets to which one resource is mapped is different.

In the resource mapping mode i, one resource including L sub-channels is mapped to ki RB sets. The value of ki is different in different mapping modes i.

According to the above description:

In the resource mapping mode 1, one resource including L sub-channels is mapped to k1 RB sets.

In the resource mapping mode 2, one resource including L sub-channels is mapped to k2 RB sets.

In the resource mapping mode 3, one resource including L sub-channels is mapped to k3 RB sets.

The values of k1, k2, and k3 are different.

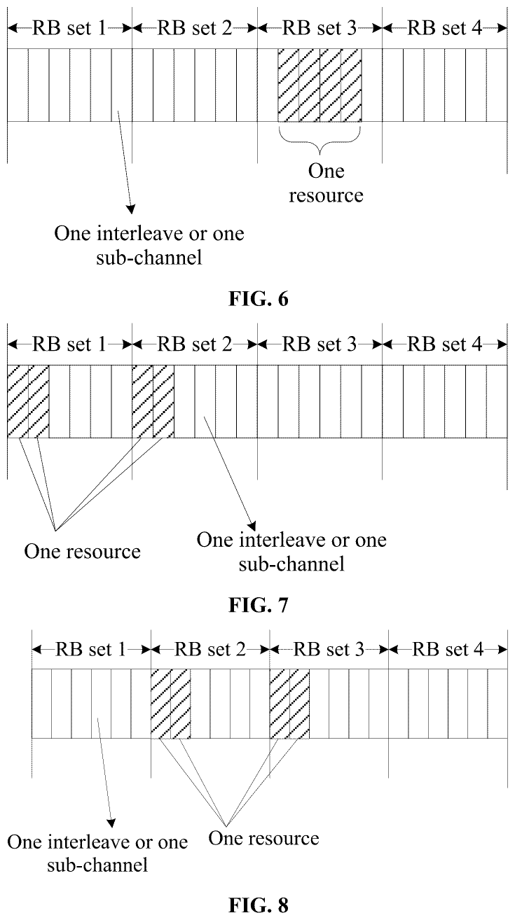

FIG. 5 is a schematic diagram of the mapping of one resource to first frequency domain units in one resource mapping mode according to an embodiment of the present application, and FIG. 6 is a schematic diagram of the mapping of another resource to first frequency domain units in the one resource mapping mode according to an embodiment of the present application. The first second resource set in FIG. 4 corresponds to the resource mapping mode 1, and each resource in the first second resource set is mapped to L sub-channels. When L=4, as shown in FIGS. 5 and 6, one resource corresponding to the resource mapping mode 1 is mapped to k1=1 RB set, that is, one resource corresponding to the resource mapping mode 1 is distributed in k1=1 RB set. The resource mapping mode 1 corresponds to the first second resource set, FIG. 5 shows one resource in the first second resource set, and FIG. 6 shows another resource in the first second resource set. Other resources included in the first second resource set are not shown in the figures.

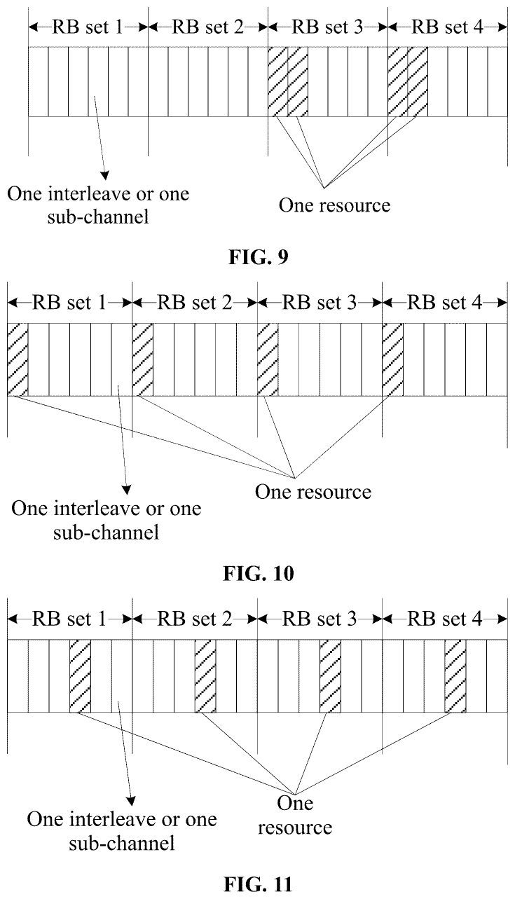

FIG. 7 is a schematic diagram of the mapping of one resource to first frequency domain units in another resource mapping mode according to an embodiment of the present application, FIG. 8 is a schematic diagram of the mapping of another resource to first frequency domain units in the another resource mapping mode according to an embodiment of the present application, and FIG. 9 is a schematic diagram of the mapping of yet another resource to first frequency domain units in the another resource mapping mode according to an embodiment of the present application. The second second resource set in FIG. 4 corresponds to the resource mapping mode 2, and each resource in the second second resource set is mapped to L sub-channels. When L=4, as shown in FIGS. 7 to 9, one resource corresponding to the resource mapping mode 2 is mapped to k2=2 RB sets, that is, one resource corresponding to the resource mapping mode 2 is distributed in k2=2 RB sets. The resource mapping mode 2 corresponds to the second second resource set, and FIGS. 7 to 9 show one resource, another resource, and yet another resource in the second second resource set, respectively. Other resources included in the second second resource set are not shown in the figures.

FIG. 10 is a schematic diagram of the mapping of one resource to first frequency domain units in yet another resource mapping mode according to an embodiment of the present application, and FIG. 11 is a schematic diagram of the mapping of another resource to first frequency domain units in the yet another resource mapping mode according to an embodiment of the present application. The third second resource set in FIG. 4 corresponds to the resource mapping mode 3, and each resource in the third second resource set is mapped to L sub-channels. When L=4, as shown in FIGS. 10 and 11, one resource corresponding to the resource mapping mode 3 is mapped to k3=4 RB sets, that is, one resource corresponding to the resource mapping mode 3 is distributed in k3=4 RB sets. The resource mapping mode 3 corresponds to the third second resource set, and FIGS. 10 and 11 show one resource and another resource in the third second resource set, respectively. Other resources included in the third second resource set are not shown in the figures.

In any resource mapping mode i, any resource in the second resource set (labeled as the i-th second resource set) corresponding to the resource mapping mode i includes L sub-channels. One resource including L sub-channels is mapped to ki RB sets. The value of ki is different in different resource mapping modes i.

In an example, in any resource mapping mode i, the value of corresponding ki is divisible by L.

In FIG. 5 or 6, one resource corresponding to the resource mapping mode 1 includes L=4 sub-channels, and the one resource is mapped to k1=1 RB set, where k1=1 is divisible by L=4.

In FIGS. 7 to 9, one resource corresponding to the resource mapping mode 2 includes L=4 sub-channels, and the one resource is mapped to k2=2 RB sets, where k2=2 is divisible by L=4.

In FIGS. 10 and 11, one resource corresponding to the resource mapping mode 3 includes L=4 sub-channels, and the one resource is mapped to k3=4 RB sets, where k3=4 is divisible by L=4.

In an example, in any resource mapping mode i, one resource is mapped to ki RB sets, and the one resource is mapped to L/ki sub-channels in each of the ki RB sets, where L/ki is a positive integer.

In FIG. 5 or 6, one resource corresponding to the resource mapping mode 1 includes L=4 sub-channels, the one resource is mapped to k1=1 RB set, and the k1=1 RB set includes L/k1=4 sub-channels occupied by the one resource.

In FIGS. 7 to 9, one resource corresponding to the resource mapping mode 2 includes L=4 sub-channels, the one resource is mapped to k2=2 RB sets, and each of the k2=2 RB sets includes L/k2=2 sub-channels occupied by the one resource.

In FIGS. 10 and 11, one resource corresponding to the resource mapping mode 3 includes L=4 sub-channels, the one resource is mapped to k3=4 RB sets, and each of the k3=4 RB sets includes L/k3=1 sub-channel occupied by the one resource.

In an example, in any resource mapping mode i, one resource is mapped to ki RB sets, and the one resource is mapped to several sub-channels in each of the ki RB sets, that is, the one resource occupies several sub-channels in each RB set. For any two RB sets among the ki RB sets, the sub-channel number of the first sub-channel among the sub-channels occupied by the one resource included in one RB set is the same as the sub-channel number of the first sub-channel among the sub-channels occupied by the one resource included in the other RB set. The sub-channel number here refers to the number of a sub-channel in one RB set.

Alternatively, for any two RB sets among the ki RB sets, the frequency domain location of the first sub-channel among the sub-channels occupied by the one resource included in the one RB set in one RB set is the same as the frequency domain location of the first sub-channel among the sub-channels occupied by the one resource included in the other RB set in the other RB set.

In FIG. 7, one resource corresponding to the resource mapping mode 2 includes L=4 sub-channels, and the one resource is mapped to k2=2 RB sets. The RB set 1 includes two sub-channels occupied by the one resource, and the sub-channel number of the first sub-channel in the RB set 1 is 0, that is, the frequency domain location of the first sub-channel in the RB set 1 is the first sub-channel in the RB set 1. The RB set 2 includes two sub-channels occupied by the one resource, and the sub-channel number of the first sub-channel in the RB set 2 is 0, that is, the frequency domain location of the first sub-channel in the RB set 2 is the first sub-channel in the RB set 2.

In FIG. 11, one resource corresponding to the resource mapping mode 3 includes L=4 sub-channels, and the one resource is mapped to k3=4 RB sets. The RB set 1 includes one sub-channel occupied by the one resource, and the sub-channel number of the first sub-channel in the RB set 1 is 3, that is, the frequency domain location of the first sub-channel in the RB set 1 is the fourth sub-channel in the RB set 1. The RB set 2 includes one sub-channel occupied by the one resource, and the sub-channel number of the first sub-channel in the RB set 2 is 3, that is, the frequency domain location of the first sub-channel in the RB set 2 is the fourth sub-channel in the RB set 2. The RB set 3 includes one sub-channel occupied by the one resource, and the sub-channel number of the first sub-channel in the RB set 3 is 3, that is, the frequency domain location of the first sub-channel in the RB set 3 is the fourth sub-channel in the RB set 3. The RB set 4 includes one sub-channel occupied by the one resource, and the sub-channel number of the first sub-channel in the RB set 4 is 3, that is, the frequency domain location of the first sub-channel in the RB set 4 is the fourth sub-channel in the RB set 4.

### Embodiment Two

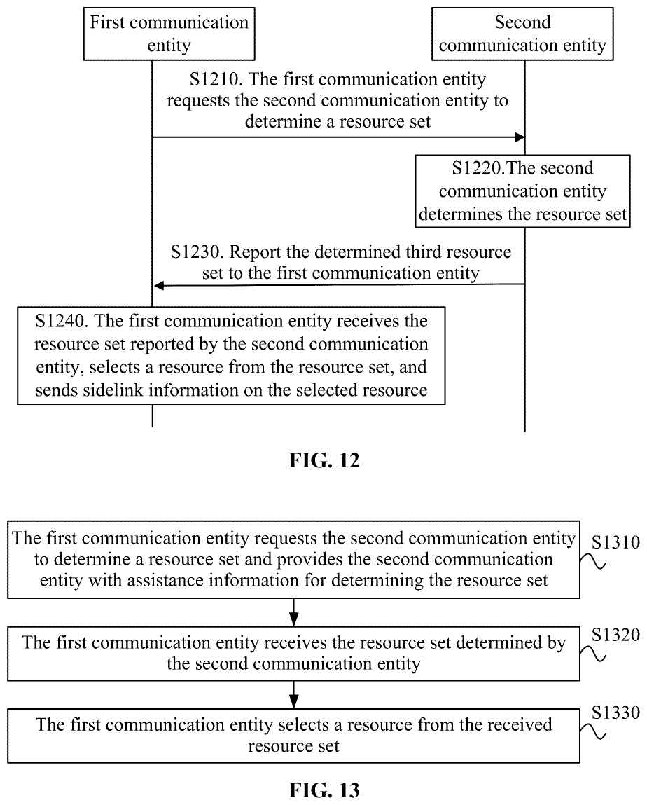

In this embodiment, the interaction process of the first communication entity and the second communication entity is described below. FIG. 12 is a schematic diagram of the interaction between the first communication entity and the second communication entity according to an embodiment of the present application. As shown in FIG. 12, the interaction process of the first communication entity and the second communication entity includes S1201 to S1204.

S1210, the first communication entity requests the second communication entity to determine a resource set.

In S1220, the second communication entity determines the resource set.

In S1230, the determined third resource set is reported to the first communication entity.

In S1240, the first communication entity receives the resource set reported by the second communication entity, selects a resource from the resource set, and sends sidelink information on the selected resource.

In this embodiment, the first communication entity requests the second communication entity to determine a resource set. After the second communication entity receives the request of the first communication entity, the second communication entity determines the resource set based on assistance information. The assistance information is used for determining the resource set. The assistance information used for determining the resource set includes a resource mapping mode. The resource mapping mode includes at least one of the following: first frequency domain units to which a resource is mapped or the number of first frequency domain units to which a resource is mapped, where the first frequency domain unit is an RB set or the first frequency domain unit is a frequency domain unit including a bandwidth of 20 MHz.

In this embodiment, the resource mapping mode is used for characterizing the number of first frequency domain units to which one resource is mapped, and in different resource mapping modes, the number of first frequency domain units to which one resource is mapped is different.

In an embodiment, the first frequency domain unit is an RB set, and one resource pool includes Y RB sets. The second communication entity determines a resource mapping mode of each resource including L sub-channels in the resource pool based on a preset rule. The preset rule includes the following.

The number M of resource mapping modes corresponding to one resource pool is less than or equal to Y and is a positive divisor of L, and the values of the M resource mapping modes are labeled as Z₁, Z₂, . . . , and Z_{M}, respectively; and for an m-th resource mapping mode, one resource is mapped to Zₘ RB sets in the resource pool, where Zₘ is a positive divisor of L, m is a positive integer less than or equal to m, and values of Zₘ corresponding to different values of m different.

M resource mapping modes corresponding to one resource pool are labeled as a first resource mapping mode, a second resource mapping mode, . . . , and an M-th resource mapping mode, respectively. In the first resource mapping mode, one resource is mapped to Z₁ RB sets in the resource pool; in the second resource mapping mode, one resource is mapped to Z₂ RB sets in the resource pool; . . . ; and in the M-th resource mapping mode, one resource is mapped to Z_{M} RB sets in the resource pool; where the mapping mode of one resource characterizes the number of RB sets to which one resource is mapped.

According to the above characteristics, the second communication entity acquires assistance information indicating the resource mapping mode of each resource including L sub-channels in one resource pool.

In an example, Y=4, and L=4. Based on the above preset rule, the positive divisor less than or equal to Y of L includes M=3 values, that is, Z₁=1, Z₂=2, and Z₃=4. For resources each including L=4 sub-channels in the resource pool, there are M=3 resource mapping modes: a resource mapping mode 1, a resource mapping mode 2, and a resource mapping mode 3. In the resource mapping mode 1, the resource is mapped to Z₁=1 RB set in the resource pool, as shown in FIGS. 5 and 6. In the resource mapping mode 2, the resource is mapped to Z₂=2 RB sets in the resource pool, as shown in FIGS. 7 to 9. In the resource mapping mode 3, the resource is mapped to Z₃=4 RB sets in the resource pool, as shown in FIGS. 10 and 11.

In an embodiment, the second communication entity acquires the assistance information, including the assistance information sent by the first communication entity or the third communication entity, where the assistance information includes the number of RB sets to which a resource is mapped.

In an example, a resource mapping mode is acquired by receiving the assistance information sent by the first communication entity or the third communication entity. The acquired resource mapping mode includes at least one of a first resource mapping mode, a second resource mapping mode or a third resource mapping mode. In the first resource mapping mode, as shown in FIGS. 5 and 6, one resource is mapped to one RB set. In the second resource mapping mode, as shown in FIGS. 7 to 9, one resource is mapped to two RB sets. In the third resource mapping mode, as shown in FIGS. 10 and 11, one resource is mapped to four RB sets.

In an embodiment, the first communication entity or the third communication entity indicates the resource mapping mode through the sent assistance information. The manner of indicating the resource mapping mode includes at least one of the following: the resource mapping mode is indicated by indicating an index of the resource mapping mode; the resource mapping mode is indicated through a bitmap; the resource mapping mode is indicated by indicating the sum of indexes of one or more resource mapping modes and the number of resource mapping modes; or the resource mapping mode is indicated by indicating the number of RB sets corresponding to the resource mapping mode.

In an example, there are three resource mapping modes, and the resource mapping modes having indexes of 1, 2, and 3 are labeled as the resource mapping mode 1, the resource mapping mode 2, and the resource mapping mode 3, respectively. The numbers of RB sets mapped to in the resource mapping mode 1, the resource mapping mode 2, and the resource mapping mode 3 are 1, 2, and 3, respectively.

The first communication entity indicates the resource mapping mode 2 and the resource mapping mode 3, and the first communication entity indicates that the number of resource mapping modes is 2 and the sum of the indexes of the resource mapping modes is 5.

After the second communication entity obtains the assistance information, the second communication entity determines the resource set based on the assistance information.

In an embodiment, the first resource set includes several candidate resources. The first resource set includes N second resource sets, and one second resource set corresponds to one resource mapping mode. The second communication entity performs resource exclusion on the first resource set to determine one resource set. The determined resource set is labeled as a third resource set. The third resource set includes N1 fourth resource sets, and one fourth resource set corresponds to one resource mapping mode.

In an embodiment, the first resource set includes several candidate resources. The first resource set includes N second resource sets, and one second resource set corresponds to one resource mapping mode. The second communication entity separately performs resource exclusion on the N second resource sets to determine N resource sets. The N resource sets are labeled as a fifth resource set. One fifth resource set corresponds to one resource mapping mode.

The second communication entity reports the determined resource set to the first communication entity.

The first communication entity receives the resource set/the resource sets reported by the second communication entity, selects a resource from the resource set/these resource sets, and sends sidelink information on the selected resource.

### Embodiment Three

In this embodiment, the first communication entity sends assistance information to the second communication entity, and the communication process between the first communication entity and the second communication entity is described below. In an embodiment, the first communication entity and the second communication entity include one of the following cases: the first communication entity is a MAC layer of a first UE, and the second communication entity is a physical layer of the first UE; the first communication entity is a first UE, and the second communication entity is a second UE; or the first communication entity is a sidelink module 1 of a first UE, and the second communication entity is a sidelink module 2 of the first UE.

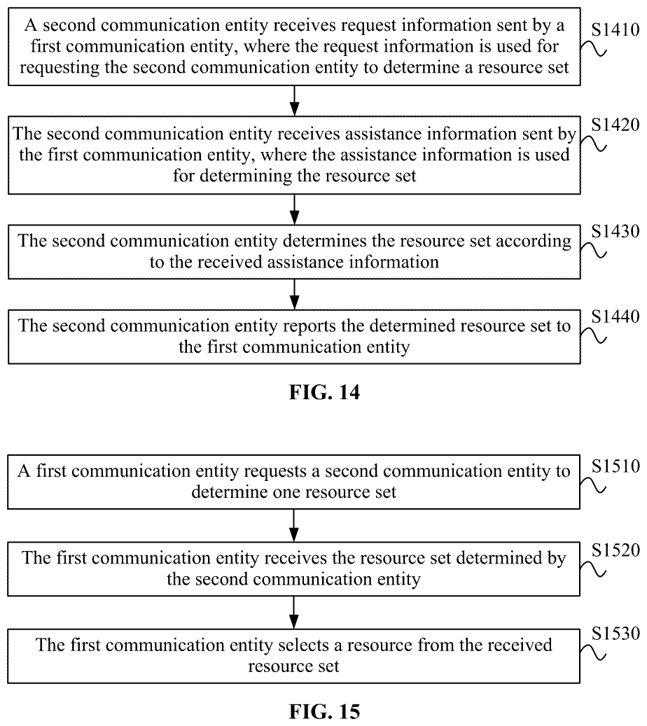

FIG. 13 is a schematic diagram of the communication of the first communication entity according to an embodiment of the present application, and FIG. 14 is a schematic diagram of the communication of the second communication entity according to an embodiment of the present application.

As shown in FIG. 13, the communication process of the first communication entity in this embodiment includes S1310 to S1330.

In S1310, the first communication entity requests the second communication entity to determine a resource set and provides the second communication entity with assistance information for determining the resource set.

S1320, the first communication entity receives the resource set determined by the second communication entity.

In S1330, the first communication entity selects a resource from the received resource set.

In this embodiment, the first communication entity requests the second communication entity to determine a resource set and provides the second communication entity with assistance information for determining the resource set. The assistance information includes a resource mapping mode. The resource mapping mode is used for characterizing the number of RB sets to which one resource is mapped, and in different resource mapping modes, the number of RB sets to which one resource is mapped is different.

In an embodiment, the first communication entity provides the second communication entity with assistance information used for determining the resource set by sending the assistance information used for determining the resource set to the second communication entity.

In an example, one resource is mapped to L=4 sub-channels, and each sub-channel includes several frequency domain RBs or several frequency domain interleaved resources. The one resource being mapped to L=4 sub-channels may be referred to as the one resource including L=4 sub-channels. FIG. 5 or 6 corresponds to a resource mapping mode 1. In the resource mapping mode 1, one resource including L=4 sub-channels is mapped to one RB set. FIGS. 7 to 9 correspond to a resource mapping mode 2. In the resource mapping mode 2, one resource including L=4 sub-channels is mapped to two RB sets. FIGS. 10 and 11 correspond to a resource mapping mode 3. In the resource mapping mode 3, one resource including L=4 sub-channels is mapped to four RB sets.

As shown in FIG. 14, the communication process of the second communication entity in this embodiment includes S1410 to S1440.

In S1410, the second communication entity receives request information sent by the first communication entity, where the request information is used for requesting the second communication entity to determine a resource set.

In S1420, the second communication entity receives assistance information sent by the first communication entity, where the assistance information is used for determining the resource set.

In S1430, the second communication entity determines the resource set according to the received assistance information.

In S1440, the second communication entity reports the determined resource set to the first communication entity.

In this embodiment, the second communication entity acquires request information for determining a resource set from the first communication entity and acquires assistance information provided by the first communication entity for the second communication entity for determining the resource set.

The second communication entity determines the resource set based on the assistance information.

In an embodiment, the resource set determined by the second communication entity includes one resource set.

In an embodiment, the resource set determined by the second communication entity includes multiple resource sets.

In an embodiment, the resource set is determined by performing resource exclusion on the resource set determined by the second communication entity.

The second communication entity reports the determined resource set to the first communication entity.

The first communication entity receives the resource set/the resource sets which are determined by the second communication entity and then reported by the second communication entity and selects a resource from the resource set/these resource sets, and a user equipment corresponding to the first communication entity sends communication information on the selected resource.

### Embodiment Four

In this embodiment, the third communication entity sends assistance information to the second communication entity, and the communication process between the first communication entity and the second communication entity is described below.

In an embodiment, the first communication entity, the second communication entity, and the third communication entity include one of the following cases.

The first communication entity is a MAC layer of a first UE, the second communication entity is a physical layer of the first UE, and the third communication entity is a base station; or the first communication entity is a MAC layer of a first UE, the second communication entity is a physical layer of the first UE, and the third communication entity is an RRC layer of the first UE.

In an embodiment, FIG. 15 is a schematic diagram of another communication of the first communication entity according to an embodiment of the present application. As shown in FIG. 15, the communication process of the first communication entity in this embodiment includes S1510 to S1530.

S1510, the first communication entity requests the second communication entity to determine one resource set.

S1520, the first communication entity receives the resource set determined by the second communication entity.

In S1530, the first communication entity selects a resource from the received resource set.

In this embodiment, the first communication entity requests the second communication entity to determine a resource set, and the third communication entity provides the second communication entity with assistance information for determining the resource set. The assistance information includes a resource mapping mode. The resource mapping mode is used for characterizing the number of RB sets to which one resource is mapped, and in different resource mapping modes, the number of RB sets to which one resource is mapped is different.

FIG. 5 or 6 corresponds to a resource mapping mode 1. In the resource mapping mode 1, one resource including L=4 sub-channels is mapped to one RB set. FIGS. 7 to 9 correspond to a resource mapping mode 2. In the resource mapping mode 2, one resource including L=4 sub-channels is mapped to two RB sets. FIGS. 10 and 11 correspond to a resource mapping mode 3. In the resource mapping mode 3, one resource including L=4 sub-channels is mapped to four RB sets.

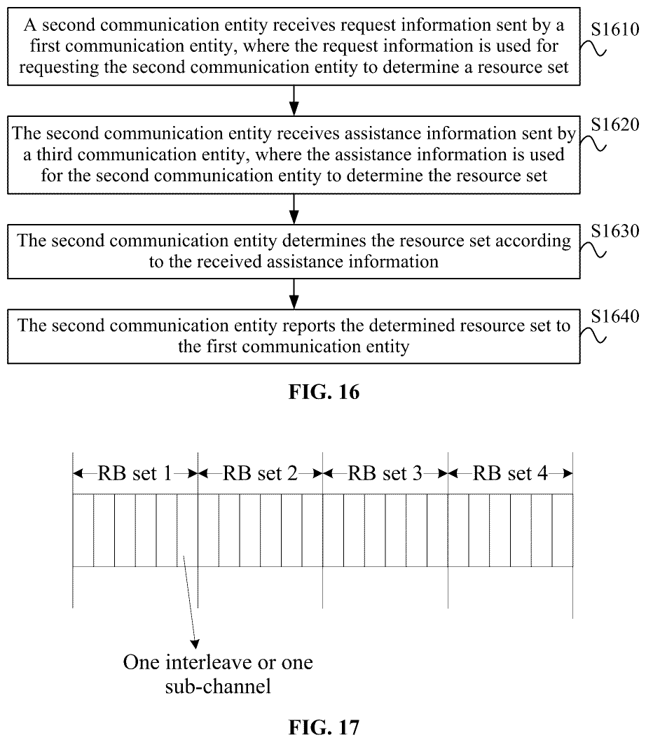

In an embodiment, FIG. 16 is a schematic diagram of another communication of the second communication entity according to an embodiment of the present application. As shown in FIG. 16, the communication process of the second communication entity in this embodiment includes S1610 to S1640.

In S1610, the second communication entity receives request information sent by the first communication entity, where the request information is used for requesting the second communication entity to determine a resource set.

In S1620, the second communication entity receives assistance information sent by the third communication entity, where the assistance information is used for the second communication entity to determine the resource set.

In S1630, the second communication entity determines the resource set according to the received assistance information.

In S1640, the second communication entity reports the determined resource set to the first communication entity.

In this embodiment, the second communication entity acquires request information for determining a resource set from the first communication entity and acquires assistance information provided by the third communication entity for the second communication entity for determining the resource set. The second communication entity determines the resource set based on the assistance information.

In an embodiment, the resource set is determined by performing resource exclusion on the resource set determined by the second communication entity.

The second communication entity reports the determined resource set to the first communication entity.

The first communication entity receives the resource set/the resource sets which are determined by the second communication entity and then reported by the second communication entity and selects a resource from the resource set/these resource sets, and a user equipment corresponding to the first communication entity sends communication information on the selected resource.

### Embodiment Five

In an embodiment, the first resource set includes N second resource sets. One second resource set corresponds to one resource mapping mode. In different resource mapping modes, the number of first frequency domain units to which a resource in the second resource set is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

In an example, the first resource set includes N=3 second resource sets, which are a first second resource set, a second second resource set, and a third second resource set, respectively. These three second resource sets correspond to a resource mapping mode 1, a resource mapping mode 2, and a resource mapping mode 3, respectively. In the resource mapping mode 1, a resource including L sub-channels is mapped to one RB set. In the resource mapping mode 2, a resource including L sub-channels is mapped to two RB sets. In the resource mapping mode 3, a resource including L sub-channels is mapped to four RB sets.

In an embodiment, the operation where the second community entity determines the resource set based on the assistance information including a resource mapping mode includes the following operations: RSRP measurement is performed, and resource exclusion is performed on the first resource set based on the RSRP measurement result to determine a third resource set, where the determined third resource set is remaining resources after resource exclusion. The second communication entity reports the determined third resource set to the first communication entity.

The third resource set includes N1 fourth resource sets. One fourth resource set corresponds to one resource mapping mode, and in different resource mapping modes, the number of RB sets to which one resource is mapped is different. The second communication entity determines the first resource set based on the resource mapping mode. In an example, FIG. 17 is a schematic diagram of the configuration of first frequency domain units and second frequency domain units according to an embodiment of the present application. As shown in FIG. 17, one resource pool includes an RB set 1, an RB set 2, an RB set 3, and an RB set 4, and each of these RB sets includes six second frequency domain units. It is assumed that one resource includes L=4 second frequency domain units and the resource mapping mode includes a resource mapping mode 1 and a resource mapping mode 2. A resource corresponding to the resource mapping mode 1 and a resource corresponding to the resource mapping mode 2 are mapped to one RB set and two RB sets, respectively. At this point, the second communication entity determines a first resource set based on the resource mapping mode, and the first resource set includes a first second resource set and a second second resource set. The first second resource set corresponds to the resource mapping mode 1. The resources in the first second resource set are as shown in FIGS. 5 and 6. Each resource in the first second resource set includes L=4 second frequency domain units, and each of these resources is mapped to one RB set. The first second resource set includes 12 resources, and other resources other than the resources shown in FIGS. 5 and 6 are not shown in the figures. The second second resource set corresponds to the resource mapping mode 2. The resources in the second second resource set are shown in FIGS. 7 to 9. Each resource in the second second resource set includes L=4 second frequency domain units, and each of these resources is mapped to two consecutive RB sets. The second second resource set includes 15 resources, and other resources other than the resources shown in FIGS. 7 to 9 are not shown in the figures.

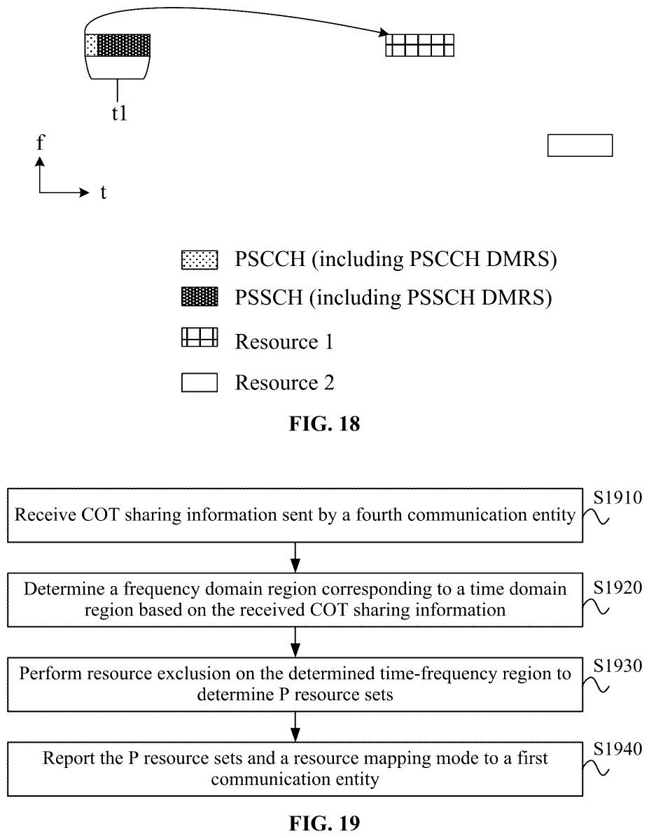

The second communication entity performs RSRP measurement. In an example, FIG. 18 is a schematic diagram of the RSRP measurement of one resource according to an embodiment of the present application. The RSRP measurement performed on one resource is shown in FIG. 18. A resource 1 and a resource 2 on which RSRP measurement is to be performed are shown in FIG. 18. The UE 1 sends sidelink control information (SCI) and a physical sidelink shared channel (PSSCH) in a slot t1, where the SCI sent by the UE 1 is carried through a physical sidelink control channel (PSCCH) sent by the UE 1. The UE 1 also sends a PSCCH demodulation reference signal (DMRS) and a PSSCH DMRS in the slot t1. The SCI sent by the UE 1 in the slot t1 includes an indication indicating time-frequency resources reserved by the UE 1, and the indicated time-frequency resources include a time-frequency resource overlapping with the resource 1. The second communication entity performs RSRP measurement on the PSCCH DMRS or the PSSCH DMRS sent by the UE 1 in the slot t1, and the resulting RSRP measurement result is taken as the RSRP value of the resource 1. For the resource 2, the resource 2 does not overlap with the resources reserved by any other user equipment, and the measured RSRP value corresponding to the resource 2 is assumed to be negative infinity dBm, that is, the RSRP value corresponding to the resource 2 is negative infinity dBm.

The second communication entity determines one third resource set through resource exclusion. The second communication entity determines the RSRP values of resources in the first resource set according to RSRP measurement results and excludes resources whose RSRP values are higher than an RSRP threshold value in the first resource set. The remaining resources after resource exclusion are labeled as the third resource set.

The second communication entity reports the one third resource set determined above to the first communication entity. The one third resource set includes N1 fourth resource sets. One fourth resource set corresponds to one resource mapping mode, and in different resource mapping modes, the number of RB sets to which one resource is mapped is different.

### Embodiment Six

In an embodiment, one second resource set corresponds to one resource mapping mode. In different resource mapping modes, the number of first frequency domain units to which a resource in a corresponding second resource set is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

In an example, in a resource mapping mode 1, a resource including L sub-channels is mapped to one RB set; in a resource mapping mode 2, a resource including L sub-channels is mapped to two RB sets; in a resource mapping mode 3, a resource including L sub-channels is mapped to four RB sets. A first second resource set, a second second resource set, and a third second resource set correspond to the resource mapping mode 1, the resource mapping mode 2, and the resource mapping mode 3, respectively. The union of these three second resource sets is labeled as a first resource set.

In an embodiment, the operation where the second community entity determines the resource set based on the assistance information including resource mapping modes includes the following operations: N second resource sets are determined based on the resource mapping modes, and resource exclusion is separately performed on the N second resource sets to determine N fifth resource sets. The second communication entity reports the determined fifth resource sets to the first communication entity.

N second resource sets are determined based on N resource mapping modes, and one second resource set corresponds to one resource mapping mode. One fifth resource set corresponds to one resource mapping mode.

In different resource mapping modes, the number of RB sets to which one resource is mapped is different. The second communication entity determines N second resource sets based on N resource mapping modes. In an example, as shown in FIG. 17, one resource pool includes an RB set 1, an RB set 2, an RB set 3, and an RB set 4, and each of these RB sets includes six second frequency domain units. It is assumed that one resource includes L=4 second frequency domain units and there are N=2 resource mapping modes: a resource mapping mode 1 and a resource mapping mode 2. A resource corresponding to the resource mapping mode 1 and a resource corresponding to the resource mapping mode 2 are mapped to one RB set and two RB sets, respectively.

At this point, the second communication entity determines N=2 second resource sets based on N=2 resource mapping modes.

In the resource mapping mode 1, a resource including L=4 second frequency domain units is mapped to one RB set. The first second resource set corresponding to the resource mapping mode 1 determined by the second communication entity includes the resources shown in FIGS. 5 and 6. The first second resource set determined by the second communication entity according to the resource mapping mode 1 includes 12 resources, and other resources other than the resources shown in FIGS. 5 and 6 are not shown in the figures.

In the resource mapping mode 2, a resource including L=4 second frequency domain units is mapped to two RB sets. The second second resource set corresponding to the resource mapping mode 2 determined by the second communication entity includes the resources shown in FIGS. 7 to 9. The second second resource set determined by the second communication entity according to the resource mapping mode 2 includes 15 resources, and other resources other than the resources shown in FIGS. 7 to 9 are not shown in the figures.

The union of the first second resource set and the second second resource set is labeled as a first resource set.

The second communication entity separately performs resource exclusion on the N second resource sets to determine N fifth resource sets.

In an embodiment, the second communication entity performs RSRP measurement on resources in each second resource set and performs resource exclusion based on the RSRP measurement result to exclude resources whose RSRP values are higher than an RSRP threshold value in the second resource set. N sets of remaining resources are obtained by separately performing resource exclusion on the N second resource sets, and these N sets of remaining resources are taken as the N fifth resource sets determined by the second communication entity.

The second communication entity reports the determined N fifth resource sets to the first communication entity. One fifth resource set corresponds to one resource mapping mode, and in different resource mapping modes, the number of RB sets to which one resource is mapped is different.

### Embodiment Seven

In an embodiment, the first resource set includes N second resource sets. One second resource set corresponds to one resource mapping mode. In different resource mapping modes, the number of first frequency domain units to which a resource in a corresponding second resource set is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

In an example, the first resource set includes N=3 second resource sets, which are a first second resource set, a second second resource set, and a third second resource set, respectively. These three second resource sets correspond to a resource mapping mode 1, a resource mapping mode 2, and a resource mapping mode 3, respectively. In the resource mapping mode 1, a resource including L sub-channels is mapped to one RB set. In the resource mapping mode 2, a resource including L sub-channels is mapped to two RB sets. In the resource mapping mode 3, a resource including L sub-channels is mapped to four RB sets.

The second communication entity performs resource exclusion on the first resource set to determine one third resource set. The determined third resource set is the remaining resources after resource exclusion.

The second communication entity reports the determined third resource set to the first communication entity, and the third resource set includes N1 fourth resource sets.

In an embodiment, the second communication entity reports the determined third resource set to the first communication entity and reports the resource mapping mode of each resource in the third resource set.

In an embodiment, one fourth resource set corresponds to one resource mapping mode. The N1 fourth resource sets are sorted according to resource mapping modes. For example, the third resource set includes N=3 fourth resource sets, and a first fourth resource set, a second fourth resource set, and a fourth second resource set correspond to a resource mapping mode 1, a resource mapping mode 2, and a resource mapping mode 3, respectively. The fourth resource sets are sorted according to predetermined resource mapping modes.

In an embodiment, the N1 fourth resource sets are sorted according to the number of RB sets corresponding to the resource mapping mode in ascending order. The numbers of RB sets mapped to in the resource mapping mode 1, the resource mapping mode 2, and the resource mapping mode 3 are 1, 2, and 4, respectively, and these three resource mapping modes correspond to the first fourth resource set, the second fourth resource set, and the third fourth resource set, respectively. When these three fourth resource sets are sorted according to the number of RB sets corresponding to the resource mapping mode in ascending order, the resources in the first fourth resource set corresponding to the resource mapping mode 1 are resources ranked in the front of the third resource set; the resources in the second fourth resource set corresponding to the resource mapping mode 2 are resources ranked in the middle in the third resource set; the resources in the third fourth resource set corresponding to the resource mapping mode 3 are resources ranked in the back of the third resource set.

### Embodiment Eight

In an embodiment, one second resource set corresponds to one resource mapping mode. In different resource mapping modes, the number of first frequency domain units to which a resource in a corresponding second resource set is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

The second communication entity separately performs resource exclusion on the N second resource sets to determine N fifth resource sets.

In an example, in a resource mapping mode 1, a resource including L sub-channels is mapped to one RB set; in a resource mapping mode 2, a resource including L sub-channels is mapped to two RB sets; in a resource mapping mode 3, a resource including L sub-channels is mapped to four RB sets. A first second resource set, a second second resource set, and a third second resource set correspond to the resource mapping mode 1, the resource mapping mode 2, and the resource mapping mode 3, respectively. The union of these three second resource sets is labeled as a first resource set. The resource set corresponding to the remaining resources of the first second resource set after resource exclusion is labeled as a first fifth resource set. The resource set corresponding to the remaining resources of the second second resource set after resource exclusion is labeled as a second fifth resource set. The resource set corresponding to the remaining resources of the third second resource set after resource exclusion is labeled as a third fifth resource set.

In an embodiment, the second communication entity reports the N fifth resource sets and the resource mapping mode corresponding to each fifth resource set to the first communication entity. The second communication entity reports the first fifth resource set and reports the resource mapping mode 1 corresponding to the first fifth resource set, that is, the resource mapping mode where a resource is mapped to one RB set. The second communication entity reports the second fifth resource set and reports the resource mapping mode 2 corresponding to the second fifth resource set, that is, the resource mapping mode where a resource is mapped to two RB sets. The second communication entity reports the third fifth resource set and reports the resource mapping mode 3 corresponding to the third fifth resource set, that is, the resource mapping mode where a resource is mapped to four RB sets.

In an embodiment, the second communication entity reports the N fifth resource sets and the resource mapping mode of each resource in each of the N fifth resource sets to the first communication entity. The second communication entity reports the first fifth resource set and reports that the resource mapping mode corresponding to each resource in the first fifth resource set is the resource mapping mode 1, that is, the resource mapping mode where a resource is mapped to one RB set. The second communication entity reports the second fifth resource set and reports that the resource mapping mode corresponding to each resource in the second fifth resource set is the resource mapping mode 2, that is, the resource mapping mode where a resource is mapped to two RB sets. The second communication entity reports the third fifth resource set and reports that the resource mapping mode corresponding to each resource in the third fifth resource set is the resource mapping mode 3, that is, the resource mapping mode where a resource is mapped to four RB sets.

In an embodiment, the second communication entity reports the N fifth resource sets to the first communication entity and reports the N fifth resource sets sorted according to the resource mapping mode. The N fifth resource sets are sorted according to the number of RB sets corresponding to the resource mapping mode in ascending order. The second communication entity reports N=3 fifth resource sets to the first communication entity. The first fifth resource set corresponds to the resource mapping mode 1, and the resource mapping mode 1 corresponds to one RB set. The second fifth resource set corresponds to the resource mapping mode 2, and the resource mapping mode 2 corresponds to two RB sets. The third fifth resource set corresponds to the resource mapping mode 3, and the resource mapping mode 3 corresponds to four RB sets. Therefore, the first fifth resource set is ranked in the front, the second fifth resource set is ranked in the middle, and the third fifth resource set is ranked in the back.

### Embodiment Nine

In an embodiment, one second resource set corresponds to one resource mapping mode. In different resource mapping modes, the number of first frequency domain units to which a resource in a corresponding second resource set is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

In an embodiment, the operation where the second communication entity separately performs resource exclusion on the N second resource sets includes the following operations.

The second communication entity receives an RRC message sent by the third communication entity, where the RRC message includes proportional value configuration information corresponding to each of the N second resource sets, the proportional value corresponding to a second resource set i is labeled as Xᵢ, and the proportional value configuration information is configuration information of X₁, X₂, . . . , and X_{N}, respectively. The second communication entity separately performs resource exclusion on the N second resource sets based on RSRP threshold values T₁, T₂, . . . , and T_{N} corresponding to the N second resource sets respectively. Before the second communication entity performs resource exclusion on any second resource set i, the second communication entity determines the RSRP threshold value Tᵢ corresponding to the second resource set i, where the determined Tᵢ meets the condition that the value of Nᵢ is greater than or equal to the product value of Xᵢ and Mᵢ.

Nᵢ is the number of remaining resources after resource exclusion is performed on the second resource set i, and Mᵢ is the total number of resources included in the second resource set i. In an example, there are N=3 second resource sets, and each resource in each second resource set includes L=4 sub-channels or L=4 interleaves.

The first second resource set corresponds to a resource mapping mode 1. As shown in FIGS. 5 and 6, each resource in the first second resource set is mapped to one RB set. The first second resource set includes M₁=12 resources, and each resource includes L=4 consecutively numbered sub-channels or L=4 consecutively numbered interleaves.

The second second resource set corresponds to a resource mapping mode 2. As shown in FIGS. 7 to 9, each resource in the second second resource set is mapped to two consecutively numbered RB sets. The second second resource set includes M₂=15 resources, and each resource includes L=4 sub-channels or L=4 interleaves. Each resource is distributed in two RB sets, and each RB set includes two consecutively numbered sub-channels or interleaves.

The third second resource set corresponds to a resource mapping mode 3. As shown in FIGS. 10 and 11, each resource in the third second resource set is mapped to four consecutively numbered RB sets. The third second resource set includes M₃=6 resources, and each resource includes L=4 sub-channels or L=4 interleaves. Each resource is distributed in four RB sets, and each RB set includes one sub-channel or interleave.

In an embodiment, the second communication entity receives an RRC message sent by the third communication entity, where the RRC message includes configuration information of each of proportional values X₁, X₂, and X₃ corresponding to N=3 second resource sets respectively, and X₁, X₂, and X₃ are configured to be 25%, 20%, and 50%, respectively.

In an embodiment, the second communication entity receives an RRC message sent by the third communication entity, where the RRC message includes the relationship between a CBR range and a proportional value for resource selection corresponding to a second resource set, and the relationship between the CBR range and the proportional value is used for determining proportional values X₁, X₂, . . . , and X_{N} corresponding to the N second resource sets respectively. The CBR is the proportion of resources whose energy values measured by the second communication entity exceed a threshold. For example, the CBR is the proportion of resources whose energy values measured by the second communication entity exceed the threshold in one resource pool.

The second communication entity determines RSRP threshold values T₁, T₂, . . . , and T_{N} corresponding to N=3 second resource sets respectively. For any second resource set i, the second communication entity determines one RSRP threshold value in dBm. If the number of remaining resources after the second communication entity excludes resources whose RSRP values are higher than the RSRP threshold value from the second resource set i is less than the product value of Xᵢ and Mᵢ, the RSRP threshold value is increased until the number of the remaining resources after resource exclusion is greater than or equal to the product value of Xᵢ and Mᵢ.

For any resource set i among N=3 second resource sets, the second communication entity compares the RSRP value corresponding to each resource in the resource set i with the RSRP threshold Tᵢ and performs resource exclusion on the resource set i through comparison.

### Embodiment Ten

In an embodiment, the second communication entity performs resource exclusion on the first resource set to determine one third resource set. The second communication entity reports the third resource set to the first communication entity. The third resource set includes N1 fourth resource sets. One fourth resource set corresponds to one resource mapping mode, and in different resource mapping modes, the number of RB sets to which one resource is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

In an example, the third resource set includes N1=3 fourth resource sets, which are a first fourth resource set, a second fourth resource set, and a third fourth resource set, respectively. These three fourth resource sets correspond to a resource mapping mode 1, a resource mapping mode 2, and a resource mapping mode 3, respectively. In the resource mapping mode 1, a resource including L sub-channels is mapped to one RB set. In the resource mapping mode 2, a resource including L sub-channels is mapped to two RB sets. In the resource mapping mode 3, a resource including L sub-channels is mapped to four RB sets.

The first communication entity receives the third resource set reported by the second communication entity.

The first communication entity selects a resource from the third resource set.

In an embodiment, the first communication entity preferentially selects a resource from a fourth resource set having a small number of RB sets. Therefore, the first communication entity preferentially selects a resource from the first fourth resource set.

### Embodiment Eleven

In an embodiment, the second communication entity performs resource exclusion on the first resource set to determine N fifth resource sets. The second communication entity reports the N fifth resource sets to the first communication entity. One fifth resource set corresponds to one resource mapping mode, and in different resource mapping modes, the number of RB sets to which one resource is mapped is different.

The first frequency domain unit is an RB set or the first frequency domain unit is a frequency domain unit including a bandwidth of 20 MHz. The RB set is several RBs included in the bandwidth of 20 MHz, for example, several consecutive RBs. Each frequency domain unit includes several sub-channels and/or several interleaves. One interleave includes several RBs that are discrete in the frequency domain. One sub-channel includes several RBs or one sub-channel includes several interleaves. The second frequency domain unit is a sub-channel or the second frequency domain unit is an interleave.

A first fifth resource set, a second fifth resource set, and a third fifth resource set correspond to a resource mapping mode 1, a resource mapping mode 2, and a resource mapping mode 3, respectively. In the resource mapping mode 1, a resource including L=4 sub-channels is mapped to one RB set. In the resource mapping mode 2, a resource including L=4 sub-channels is mapped to two RB sets. In the resource mapping mode 3, a resource including L=4 sub-channels is mapped to four RB sets.

The first communication entity receives the N=3 fifth resource sets reported by the second communication entity.

In an embodiment, the first communication entity preferentially selects a resource from a fifth resource set having a small number of RB sets. Therefore, the first communication entity preferentially selects a resource from the first fifth resource set.

### Embodiment Twelve

In an embodiment, the second communication entity determines a resource set based on assistance information, where the assistance information includes a resource mapping mode, and the resource mapping mode includes first frequency domain units to which a resource is mapped.

The first frequency domain unit is an RB set or the first frequency domain unit is a frequency domain unit including a bandwidth of 20 MHz. In an embodiment, the assistance information received by the second communication entity from the first communication entity or the third communication entity includes a resource mapping mode, and the resource mapping mode includes first frequency domain units to which a resource is mapped.

In an embodiment, the assistance information sent by the first communication entity or the third communication entity indicates that the first frequency domain units to which the resource is mapped are a first first frequency domain unit and a second first frequency domain unit in one resource pool, that is, a first RB set and a second RB set. Therefore, the second communication entity selects a resource from the resources mapped to the two RB sets. The resource that meets the requirements includes the following characteristic.

The resource is mapped to L sub-channels. A resource in FIG. 7, or a resource in FIG. 7 moving by x sub-channels or x interleaves still does not exceed the range of the first RB set and the second RB set. Resources that are mapped to the first and second RB sets and meet the above requirements include five resources.

In an embodiment, the second communication entity performs resource exclusion on the five resources, and the remaining resources after resource exclusion are taken as the resource set determined by the second communication entity.

In an embodiment, the second communication entity performs resource exclusion on resources including L sub-channels in one resource pool, and the union of the remaining resources after resource exclusion and the five resources is taken as the resource set determined by the second communication entity.

### Embodiment Thirteen

In an embodiment, FIG. 19 is a schematic diagram of yet another communication of the second communication entity according to an embodiment of the present application. As shown in FIG. 19, the communication process of the second communication entity includes S1910 to S1940.

In S1910, channel occupancy time (COT) sharing information sent by a fourth communication entity is received.

In S1920, a frequency domain region corresponding to a time domain region is determined based on the received COT sharing information.

In S1930, resource exclusion is performed on the determined time-frequency region to determine P resource sets.

In S1940, the P resource sets and a resource mapping mode are reported to a first communication entity.

In FIG. 19, the second communication entity receives COT sharing information sent by the fourth communication entity and determines the frequency domain region of a time-frequency region based on the received COT sharing information, where the COT sharing information includes RB set allocation information and/or frequency domain resource allocation information. The second communication entity performs resource exclusion on the determined time-frequency region to determine P resource sets. The second communication entity reports the determined P resource sets and one resource mapping mode or a resource mapping mode list to the first communication entity. The one resource mapping mode or one resource mapping mode in the resource mapping mode list includes at least one of the following: first frequency domain units to which a resource is mapped or the number of first frequency domain units to which a resource is mapped. The frequency domain region of the time-frequency region is a subset of frequency domain resources included in one resource pool.

In an embodiment, the COT sharing information further includes at least one of the following: a channel access priority class (CAPC) value, a remaining COT duration, a starting offset of a shared COT or a channel access type.

The CAPC value may also be referred to as a CAPC level, and the CAPC value is used for indicating a CAPC value used by a node initiating COT sharing for performing a channel access procedure. The remaining COT duration is used for indicating the remaining shareable time of the shared COT. The starting offset of the shared COT is used for indicating an offset time between the time to send the COT sharing information and the starting time of the shared COT. The channel access type is used for indicating the type of channel access procedure required to be executed to enable a node using the shared COT to send information within the shared COT.

In an embodiment, the frequency domain resources corresponding to one resource pool include R RB sets, and the frequency domain region of the time-frequency region determined by the second communication entity is S consecutive RB sets among the R RB sets, where S≤R.

In an embodiment, the first communication entity is a MAC layer of a first user equipment, the second communication entity is a physical layer of the first user equipment, and the fourth communication entity is a second user equipment.

In an embodiment, the operation where the second communication entity performs resource exclusion on the determined time-frequency region to determine P resource sets includes: each of the P resource sets is a subset of remaining resources after the second communication entity performs resource exclusion on the determined time-frequency region.

In an embodiment, the second communication entity reports the determined P resource sets and a resource mapping mode list to the first communication entity. The resource mapping modes included in the resource mapping mode list have a mapping relationship with P resource sets.

In an embodiment, the second communication entity reports P=1 resource set and one resource mapping mode to the first communication entity. Each resource in the P=1 resource set corresponds to a resource mapping mode 1, that is, P=1 resource set corresponds to the resource mapping mode 1.

In an embodiment, the second communication entity reports P=1 resource set and one resource mapping mode list to the first communication entity. Each resource in the P=1 resource set corresponds to one resource mapping mode in the resource mapping mode list. In an example, one resource mapping mode list includes a resource mapping mode 1 and a resource mapping mode 2, the first half of the resources in the P=1 resource set correspond to the resource mapping mode 1, and the second half of the resources correspond to the resource mapping mode 2.

In an embodiment, the second communication entity reports P>1 resource sets and P>1 resource mapping modes to the first communication entity. Each of the P>1 resource sets corresponds to one resource mapping mode in the P>1 resource mapping modes.

In an embodiment, the second communication entity reports P>1 resource sets and one resource mapping mode labeled as a resource mapping mode 1 to the first communication entity. All the P>1 resource sets correspond to the resource mapping mode 1.

In an embodiment, as shown in FIG. 17, in FIG. 17, the frequency domain of one resource pool includes four RB sets including an RB set 1 to an RB set 4. Each of the RB set 1 to the RB set 4 is a group of consecutive RBs except for the RBs used for a guard band among the frequency domain RBs included in a bandwidth of 20 MHz.

In an embodiment, the second communication entity receives COT sharing information sent by the fourth communication entity, where the COT sharing information includes RB set allocation information. The RB sets indicated by the RB set allocation information are consecutive RB set 2 and RB set 3 in one resource pool in FIG. 17, where “consecutive” here means that no frequency domain resource serving as the guard band exists between the RB set 2 and the RB set 3. The second communication entity determines the frequency domain region of a time-frequency region based on the RB set allocation information included in the COT sharing information, where the determined frequency domain region of the time-frequency region is the RB set 2 and the RB set 3.

In an embodiment, the second communication entity receives the COT sharing information sent by the fourth communication entity, where the COT sharing information includes frequency domain resource allocation information indicated or reserved by the second communication entity. The second communication entity determines the frequency domain region of the time-frequency region based on whether there is a frequency domain overlap between the frequency domain resources corresponding to the frequency domain resource allocation information and the RB sets included in the frequency domain of one resource pool. In an example, the frequency domain of one resource pool includes the RB set 1 to the RB set 4, and the COT sharing information includes a frequency domain resource/frequency domain resources corresponding to the frequency domain resource allocation information. There is a frequency domain overlap between this frequency domain resource/these frequency domain resources and the RB sets 2 and 3 among the RB set 1 to the RB set 4 included in the resource pool, and thus the second communication entity determines the frequency domain region of the time-frequency region to be the RB set 2 and the RB set 3.

In an embodiment, the second communication entity receives the COT sharing information sent by the fourth communication entity, where the COT sharing information includes the remaining COT duration. The second communication entity determines the time domain region of the time-frequency region based on the remaining COT duration.

In an embodiment, one resource pool includes several time-frequency resources, the frequency domain includes several frequency domain resources, and the time domain includes several time domain units. For example, each time domain unit is one slot. The time-frequency resources included in one resource pool are time-frequency resources capable of being used for SL communication (or time-frequency resources capable of being used for PSSCH transmission).

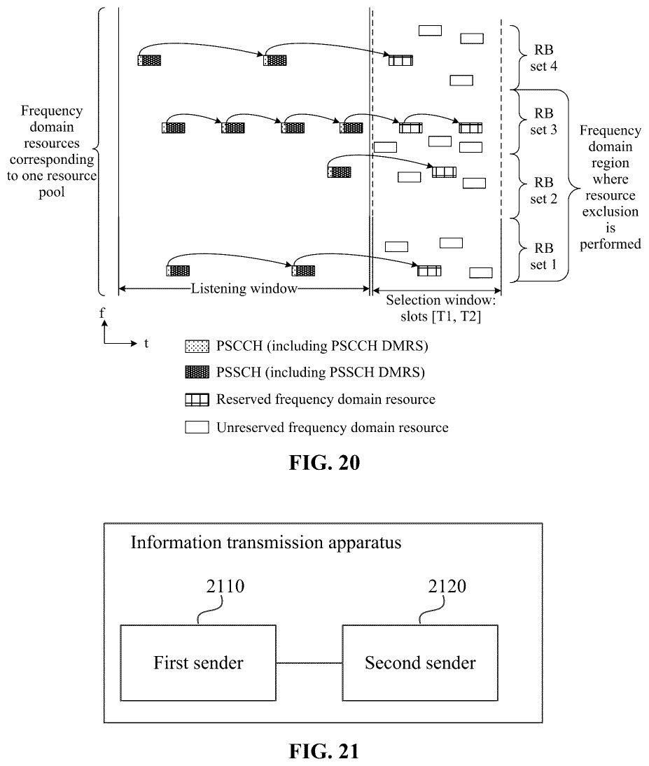

In an embodiment, the second communication entity performs resource exclusion on the determined time-frequency region to determine P=1 resource set. In an example, FIG. 20 is a schematic diagram of the determination of a resource set according to an embodiment of the present application. As shown in FIG. 20, the frequency domain corresponding to one resource pool includes an RB set 1 to an RB set 4, the frequency domain of a time-frequency region determined by the second communication entity includes the RB set 2 to the RB set 4, and the time domain of the time-frequency region determined by the second communication entity includes slots capable of being used for sidelink transmission between slots [T1, T2]. For ease of description, the time interval corresponding to the above time range [T1, T2] is labeled as a selection window. The second communication entity performs resource exclusion on the resources in the determined time-frequency region and determines P=1 resource set by performing resource exclusion.

In FIG. 20, the second communication entity performs SCI reception within the time domain listening window. The second communication entity receives SCIs sent by other terminals, and other terminals send the SCIs via PSCCHs. Other terminals send PSCCHs simultaneously in the slots where the PSCCHs are sent. Other terminals send PSCCH DMRSs simultaneously in the time-frequency region where the PSCCHs are sent. Similarly, other terminals send PSSCH DMRSs simultaneously in the time-frequency region where the PSSCHs are sent. The SCIs sent by other terminals include indications indicating the time-frequency resources reserved by other terminals.

The second communication entity determines the time-frequency resources reserved by other terminals by receiving SCIs. The second communication entity performs resource exclusion on the resources included in the time-frequency resource based on the reception of SCIs. The sidelink slots within the time domain resource selection window include several resources. Some resources overlap with the time-frequency resources reserved by other terminals, and some resources do not overlap with the time-frequency resources reserved by other terminals. The second communication entity excludes the resources whose RSRP values are higher than a threshold value by performing RSRP measurement. The remaining resources are labeled as a resource set A, that is, the resource subset of the remaining resources is labeled as the set A. For any resource among several resources included in the sidelink slots within the resource selection window, if the resource overlaps with the time-frequency resources reserved by other terminals, the second communication entity determines the RSRP value of the resource by the measuring a PSCCH DMRS or a PSSCH DMRS in a slot where the terminal which reserves the resource sends the SCI. According to the above description, the second communication entity obtains the set A by performing resource exclusion.

In an embodiment, FIG. 21 is a block diagram of an information transmission apparatus according to an embodiment of the present application. This embodiment is applied by a first communication entity. As shown in FIG. 21, the information transmission apparatus in this embodiment includes a first sender 2110 and a second sender 2120.

The first sender 2110 is configured to send request information to a second communication entity, where the request information is used for requesting the second communication entity to determine a resource set.

The second sender 2120 is configured to send assistance information for determining the resource set to the second communication entity, where the assistance information includes at least one resource mapping mode, and the resource mapping mode includes one of the following: first frequency domain units to which a resource is mapped or the number of first frequency domain units to which a resource is mapped.

In an embodiment, the assistance information further includes the number of second frequency domain units to which the resource is mapped.

In an embodiment, the first frequency domain unit includes one of the following: a resource block set or one frequency domain unit including a first preset bandwidth, and the second frequency domain unit includes one of the following: a sub-channel or an interleave.

In an embodiment, one resource corresponding to the resource mapping mode is mapped to L second frequency domain units and K first frequency domain units, where K is a positive divisor of L.

In an embodiment, the operation where one resource corresponding to the resource mapping mode is mapped to L second frequency domain units and K first frequency domain units includes at least one of the following operations.

In different resource mapping modes, the number of first frequency domain units to which one resource is mapped is different; one resource is mapped to K first frequency domain units, where each first frequency domain unit includes L/K second frequency domain units to which the resource is mapped, and L/K is a positive integer; one resource is mapped to K first frequency domain units, where the starting location of each of K first second frequency domain units to which the one resource is mapped in the K first frequency domain units are the same; or one resource is mapped to K consecutive first frequency domain units.

The information transmission apparatus provided by this embodiment is configured to perform the information transmission method applied by the first communication entity described in the embodiment shown in FIG. 1. The implementation principles and technical effects of the information transmission apparatus provided by this embodiment are similar to those of the information transmission method applied by the first communication entity described in the embodiment shown in FIG. 1 and thus are not described again here.

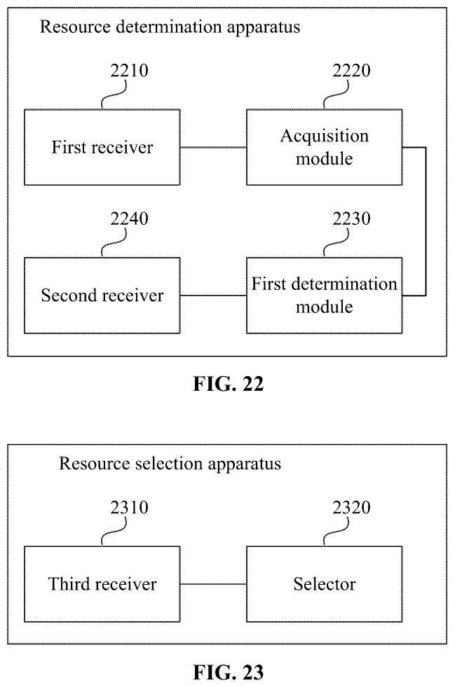

In an embodiment, FIG. 22 is a block diagram of a resource determination apparatus according to an embodiment of the present application. This embodiment is applied by a second communication entity. As shown in FIG. 22, the resource determination apparatus in this embodiment includes a first receiver 2210, an acquisition module 2220, a first determination module 2230, and a second receiver 2240.

The first receiver 2210 is configured to receive request information sent by a first communication entity, where the request information is used for requesting the second communication entity to determine a resource set.

The acquisition module 2220 is configured to acquire assistance information for determining the resource set.

The first determination module 2230 is configured to determine the resource set based on the assistance information.

The second receiver 2240 is configured to report the determined resource set to the first communication entity to cause the first communication entity to select at least one resource from the resource set for sending communication information.

The assistance information includes at least one resource mapping mode, and the resource mapping mode at least includes one of the following: first frequency domain units to which a resource is mapped or the number of first frequency domain units to which a resource is mapped.

In an embodiment, the operation where the assistance information for determining the resource set is acquired includes the following operation: a resource mapping mode corresponding to one resource pool including Y first frequency domain units is determined based on a preset rule. The preset rule includes the following.

The number M of resource mapping modes corresponding to one resource pool is less than or equal to Y and is a positive divisor of L, and the values of the M resource mapping modes are labeled as Z₁, Z₂, . . . , and Z_{M}, respectively; and for an m-th resource mapping mode, one resource is mapped to Zₘ RB sets in the resource pool, where Zₘ is a positive divisor of L, m is a positive integer less than or equal to m, and values of Zₘ corresponding to different values of m are different.

In an embodiment, the operation where the assistance information for determining the resource set is acquired includes the following operation.

Assistance information sent by the first communication entity or a third communication entity for determining the resource set is received.

In an embodiment, the first frequency domain unit includes one of the following: an RB set or one frequency domain unit including a first preset bandwidth, and the second frequency domain unit to which one resource is mapped includes one of the following: a sub-channel or an interleave.

In an embodiment, each candidate resource in a first resource set includes L second frequency domain units, and the first resource set includes N second resource sets. The operation where the resource set is determined based on the assistance information includes one of the following operations.

Resource exclusion is performed on the first resource set to determine one resource set or resource exclusion is separately performed on the N second resource sets to determine N resource sets, where one second resource set corresponds to one resource mapping mode, and in different resource mapping modes, the number of first frequency domain units to which one resource is mapped is different.

In an embodiment, the operation where resource exclusion is performed on the first resource set to determine one resource set includes the following operation.

Resource exclusion is performed on the first resource set to determine one third resource set, where the third resource set includes N1 fourth resource sets. Accordingly, the operation where the determined resource set is reported to the first communication entity includes the following operation.

The determined third resource set is reported to the first communication entity, where one fourth resource set corresponds to one resource mapping mode, and in different resource mapping modes, the number of first frequency domain units to which one resource is mapped is different.

In an embodiment, the operation where resource exclusion is separately performed on the N second resource sets to determine N resource sets includes the following operation.

Resource exclusion is separately performed on each of the N second resource sets to determine one fifth resource set for the each resource set. Accordingly, the operation where the determined resource set is reported to the first communication entity includes the following operation.

The determined N fifth resource sets are reported to the first communication entity, where one fifth resource set corresponds to one resource mapping mode, and in different resource mapping modes, the number of first frequency domain units to which one resource is mapped is different.

In an embodiment, the assistance information includes at least one resource mapping mode, and the operation where the resource set is determined based on the assistance information at least includes one of the following operations.

A first resource set and a second resource set are determined based on the resource mapping mode. A first resource set is determined based on the resource mapping mode. A second resource set is determined based on the resource mapping mode.

In an embodiment, the resource determination method applied by the second communication entity further includes the following operation: first signaling information is sent to the first communication entity, where the first signaling information is used for indicating a resource mapping mode corresponding to each of the N fifth resource sets.

In an embodiment, the resource determination method applied by the second communication entity further includes the following operation: second signaling information is sent to the first communication entity, where the second signaling information is used for indicating a resource mapping mode corresponding to each resource in each third resource set.

In an embodiment, the third resource set includes several resources. The operation where the determined third resource set is reported to the first communication entity includes the following operations.

The several resources are sorted according to the number of first frequency domain units corresponding to a resource mapping mode, and the sorted third resource set is reported to the first communication entity.

In an embodiment, the resource determination method applied by the second communication entity further includes the following operation: third signaling information is sent to the first communication entity, where the third signaling information includes the determined N fifth resource sets. The operation where the third signaling information is sent to the first communication entity includes the following operations.

The N fifth resource sets in the third signaling information are sorted according to the number of first frequency domain units corresponding to a resource mapping mode, and the sorted third signaling information is reported to the first communication entity.

In an embodiment, the operation where the several resources are sorted according to the number of first frequency domain units corresponding to the resource mapping mode includes one of the following operations.

The several resources are sorted according to the number of first frequency domain units corresponding to the resource mapping mode in ascending order. The several resources are sorted according to the number of first frequency domain units corresponding to the resource mapping mode in descending order.

In an embodiment, the operation where the N fifth resource sets are sorted according to the number of first frequency domain units corresponding to the resource mapping mode includes one of the following operations.

The N fifth resource sets are sorted according to the number of first frequency domain units corresponding to the resource mapping mode in ascending order. The N fifth resource sets are sorted according to the number of first frequency domain units corresponding to the resource mapping mode in descending order.

In an embodiment, the resource determination method applied by the second communication entity further includes the following operations.

An RRC message sent by a third communication entity is received, where the RRC message includes proportional value configuration information corresponding to each of the N second resource sets, and the proportional value corresponding to a second resource set i is labeled as Xᵢ; and an RSRP threshold value Tᵢ corresponding to the second resource set i is determined, where the RSRP threshold value Tᵢ meets the condition that the value of Nᵢ is greater than or equal to the product value of Xᵢ and Mᵢ. Accordingly, the operation where resource exclusion is separately performed on the N second resource sets includes the following operation.

Resource exclusion is separately performed on the N second resource sets based on an RSRP threshold value Tᵢ corresponding to each of the N second resource sets, where Nᵢ is the number of remaining resources after resource exclusion is performed on the second resource set i, Mᵢ is the total number of resources included in the second resource set i, and i is a positive integer greater than or equal to 1 and less than or equal to N.

In an embodiment, the RRC message further includes the relationship between a CBR range and the proportional value Xᵢ, and the relationship between the CBR range and the proportional value Xᵢ is used for determining the proportional value Xᵢ corresponding to each of the N second resource sets.

The resource determination apparatus provided by this embodiment is configured to perform the resource determination method applied by the second communication entity described in the embodiment shown in FIG. 2. The implementation principles and technical effects of the resource determination apparatus provided by this embodiment are similar to those of the resource determination method applied by the second communication entity described in the embodiment shown in FIG. 2 and thus are not described again here.

In an embodiment, FIG. 23 is a block diagram of a resource selection apparatus according to an embodiment of the present application. This embodiment is applied by a first communication entity. As shown in FIG. 23, the resource selection apparatus in this embodiment includes a third receiver 2310 and a selector 2320.

The third receiver 2310 is configured to receive a resource set reported by a second communication entity, where each resource in the resource set includes L second frequency domain units. The selector 2320 is configured to select at least one resource from the resource set to cause a user equipment corresponding to the first communication entity to send communication information using the selected at least one resource.

In an embodiment, the operation where the resource set reported by the second communication entity is received includes the following operation.

One third resource set reported by the second communication entity is received, where the third resource set includes N1 fourth resource sets, one fourth resource set corresponds to one resource mapping mode, and in different resource mapping modes, the number of first frequency domain units to which one resource is mapped is different.

In an embodiment, the operation where the resource set reported by the second communication entity is received includes the following operation.

N fifth resource sets reported by the second communication entity are received, where one fifth resource set corresponds to one resource mapping mode, and in different resource mapping modes, the number of first frequency domain units to which one resource is mapped is different.

In an embodiment, the operation where the at least one resource is selected from the resource set includes one of the following operations.

The resource is preferentially selected from a fourth resource set having a small number of first frequency domain units; the resource is preferentially selected from a fourth resource set having a large number of first frequency domain units; the resource is preferentially selected from a fifth resource set having a small number of first frequency domain units; or the resource is preferentially selected from a fifth resource set having a large number of first frequency domain units.

In an embodiment, the resource selection method applied by the first communication entity further includes the following operation: first signaling information is received, where the first signaling information is used for indicating a resource mapping mode corresponding to each fifth resource set.

In an embodiment, the resource selection method applied by the first communication entity further includes the following operation: second signaling information is received, where the second signaling information is used for indicating a resource mapping mode corresponding to each resource in each third resource set.

In an embodiment, the operation where one third resource set reported by the second communication entity is received includes the following operation.

A third resource set that is sorted according to the number of first frequency domain units corresponding to a resource mapping mode and reported by the second communication entity is received.

In an embodiment, the operation where N fifth resource sets reported by the second communication entity are received includes the following operation.

N fifth resource sets that are sorted according to the number of first frequency domain units corresponding to a resource mapping mode and reported by the second communication entity are received.

In an embodiment, the operation where sorting is performed according to the number of first frequency domain units corresponding to the resource mapping mode includes one of the following operations.

In the third resource set, sorting is performed according to the number of first frequency domain units corresponding to the resource mapping mode in ascending order; in the third resource set, sorting is performed according to the number of first frequency domain units corresponding to the resource mapping mode in descending order; in the N fifth resource sets, sorting is performed according to the number of first frequency domain units corresponding to the resource mapping mode in ascending order; or in the N fifth resource sets, sorting is performed according to the number of first frequency domain units corresponding to the resource mapping mode in descending order.

The resource selection apparatus provided by this embodiment is configured to perform the resource selection method applied by the first communication entity described in the embodiment shown in FIG. 3. The implementation principles and technical effects of the resource selection apparatus provided by this embodiment are similar to those of the resource selection method applied by the first communication entity described in the embodiment shown in FIG. 3 and thus are not described again here.

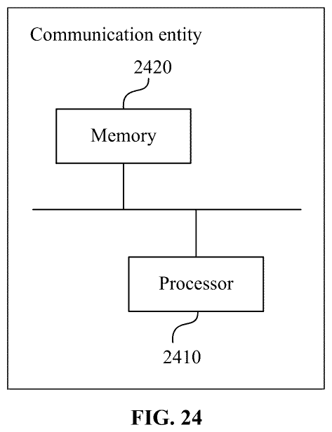

In an embodiment, FIG. 24 is a structure diagram of a communication entity according to an embodiment of the present application. As shown in FIG. 24, the communication entity provided by the present application includes a processor 2410 and a memory 2420. One or more processors 2410 may be provided in the communication entity, and one processor 2410 is shown as an example in FIG. 24. One or more memories 2420 may be provided in the communication entity, and one memory 2420 is shown as an example in FIG. 24. The processor 2410 and the memory 2420 of the communication entity may be connected via a bus or in other manners, and the connection via a bus is shown as an example in FIG. 24. In this embodiment, the communication entity may be a first communication entity.

As a computer-readable storage medium, the memory 2420 may be configured to store software programs and computer-executable programs and modules, such as program instructions/modules (for example, the first sender 2110 and the second sender 2120 in the information transmission apparatus) corresponding to the communication entity in any embodiment of the present application. The memory 2420 may include a program storage region and a data storage region. The program storage region may store an operating system and an application program required by at least one function. The data storage region may store data created according to the use of the communication entity. Additionally, the memory 2420 may include a high-speed random-access memory and may also include a nonvolatile memory such as at least one magnetic disk memory, a flash memory, or another nonvolatile solid-state memory. In some examples, the memory 2420 may include memories which are remotely disposed relative to the processor 2410, and these remote memories may be connected to the communication node via a network. Examples of the preceding network include, but are not limited to, the Internet, an intranet, a local area network, a mobile communication network, and a combination thereof.

In the case where the communication entity is the first communication entity, the communication entity may be configured to perform the information transmission method applied by the first communication entity according to any preceding embodiment and has corresponding functions and effects.

In the case where the communication entity is a second communication entity, the communication entity may be configured to perform the resource determination method applied by the second communication entity according to any preceding embodiment and has corresponding functions and effects.

In the case where the communication entity is a third communication entity, the communication entity may be configured to perform the resource selection method applied by the third communication entity according to any preceding embodiment and has corresponding functions and effects.

Embodiments of the present application also provide a storage medium including computer-executable instructions. When the computer-executable instructions are executed by a computer processor, the computer processor performs an information transmission method applied by a first communication entity. The method includes: request information is sent to a second communication entity, where the request information is used for requesting the second communication entity to determine a resource set; and assistance information for determining the resource set is sent to the second communication entity, where the assistance information includes at least one resource mapping mode, and the resource mapping mode at least includes one of the following: first frequency domain units to which a resource is mapped or the number of first frequency domain units to which a resource is mapped.

Embodiments of the present application also provide a storage medium including computer-executable instructions. When the computer-executable instructions are executed by a computer processor, the computer processor performs a resource determination method applied by a second communication entity. The method includes: request information sent by a first communication entity is received, where the request information is used for requesting the second communication entity to determine a resource set; assistance information for determining the resource set is acquired; the resource set is determined based on the assistance information; and the determined resource set is reported to the first communication entity to cause the first communication entity to select at least one resource from the resource set for sending communication information, where the assistance information includes at least one resource mapping mode, and the resource mapping mode at least includes one of the following: first frequency domain units to which a resource is mapped or the number of first frequency domain units to which a resource is mapped.

Embodiments of the present application also provide a storage medium including computer-executable instructions. When the computer-executable instructions are executed by a computer processor, the computer processor performs a resource selection method applied by a third communication entity. The method includes: a resource set reported by a second communication entity is received, where each resource in the resource set includes L second frequency domain units; and at least one resource is selected from the resource set to cause a user equipment corresponding to the first communication entity to send communication information using the selected at least one resource.

It is to be understood by those skilled in the art that the term “user equipment” encompasses any suitable type of wireless user equipment, for example, a mobile phone, a portable data processing apparatus, a portable web browser, or a vehicle-mounted mobile station.

Generally speaking, embodiments of the present application may be implemented in hardware or special-purpose circuits, software, logic, or any combination thereof. For example, some aspects may be implemented in hardware while other aspects may be implemented in firmware or software executable by a controller, a microprocessor, or another computing apparatus, though the present application is not limited thereto.

Embodiments of the present application may be implemented through the execution of computer program instructions by a data processor of a mobile apparatus, for example, implemented in a processor entity, by hardware, or by a combination of software and hardware. The computer program instructions may be assembly instructions, instruction set architecture (ISA) instructions, machine instructions, machine-related instructions, microcodes, firmware instructions, status setting data, or source or object codes written in any combination of one or more programming languages.

A block diagram of any logic flow among the drawings of the present application may represent program steps, may represent interconnected logic circuits, modules, and functions, or may represent a combination of program steps and logic circuits, modules, and functions. Computer programs may be stored in a memory. The memory may be of any type suitable for a local technical environment and may be implemented using any suitable data storage technology, such as, but not limited to, a read-only memory (ROM), a random-access memory (RAM) or an optical memory device and system (for example, a digital video disc (DVD) or a compact disc (CD)). Computer-readable media may include non-transitory storage media. The data processor may be of any type suitable for the local technical environment, such as, but not limited to, a general-purpose computer, a special-purpose computer, a microprocessor, a digital signal processor (DSP), an application-specific integrated circuit (ASIC), a field-programmable gate array (FPGA), and a processor based on a multi-core processor architecture.

1. An information transmission method, the method being applied by a first communication entity and comprising:
sending request information to a second communication entity, wherein the request information is used for requesting the second communication entity to determine a resource set; and
sending assistance information for determining the resource set to the second communication entity, wherein the assistance information comprises at least one resource mapping mode, and a resource mapping mode of the at least one resource mapping mode at least comprises one of the following: first frequency domain units to which a resource is mapped or a number of first frequency domain units to which a resource is mapped.

2. The method of claim 1, wherein the assistance information further comprises a number of second frequency domain units to which the resource is mapped.

3. The method of claim 2, wherein a first frequency domain unit of the first frequency domain units comprises one of the following: a resource block set (RB set) or one frequency domain unit comprising a first preset bandwidth; and
a second frequency domain unit of the second frequency domain units comprises one of the following: a sub-channel or an interleave.

4. (canceled)

5. The method of claim 1, wherein mapping one resource corresponding to the resource mapping mode to L second frequency domain units and to K first frequency domain units comprises at least one of the following:
in different resource mapping modes, a number of first frequency domain units to which one resource is mapped being different;
mapping one resource to K first frequency domain units, wherein each of the K first frequency domain units comprises L/K second frequency domain units to which the resource is mapped, and L/K is a positive integer;
mapping one resource to K first frequency domain units, wherein a starting location of each of K first second frequency domain units to which the one resource is mapped in the K first frequency domain units is the same; or
mapping one resource to K consecutive first frequency domain units.

6. A resource determination method, the method being applied by a second communication entity and comprising:
receiving request information sent by a first communication entity, wherein the request information is used for requesting the second communication entity to determine a resource set;
acquiring assistance information for determining the resource set;
determining the resource set based on the assistance information; and
reporting the determined resource set to the first communication entity to cause the first communication entity to select at least one resource from the resource set for sending communication information, wherein the assistance information comprises at least one resource mapping mode, and a resource mapping mode of the at least one resource mapping mode at least comprises one of the following: first frequency domain units to which a resource is mapped or a number of first frequency domain units to which a resource is mapped.

7. The method of claim 6, wherein acquiring the assistance information for determining the resource set comprises: determining a resource mapping mode corresponding to one resource pool comprising Y first frequency domain units based on a preset rule;
wherein the preset rule comprises:
a number M of resource mapping modes corresponding to one resource pool being less than or equal to Y; and
for an m-th resource mapping mode, mapping one resource to Zₘ RB sets in the resource pool, wherein Zₘ is a positive divisor of L, m is a positive integer less than or equal to m, and values of Zₘ corresponding to different values of m are different.

8. The method of claim 6, the acquiring the assistance information for determining the resource set comprises:
receiving assistance information sent by the first communication entity or a third communication entity for determining the resource set.

9. The method of claim 6, wherein a first frequency domain unit of the first frequency domain units comprises one of the following: a resource block set (RB set) or one frequency domain unit comprising a first preset bandwidth; and
a second frequency domain unit to which one resource is mapped comprises one of the following: a sub-channel or an interleave.

10. The method of claim 6, wherein each candidate resource in a first resource set comprises L second frequency domain units, and the first resource set comprises N second resource sets; determining the resource set based on the assistance information comprises one of the following:
performing resource exclusion on the first resource set to determine one resource set; and
separately performing resource exclusion on the N second resource sets to determine N resource sets;
wherein one second resource set corresponds to one resource mapping mode, and in different resource mapping modes, a number of first frequency domain units to which one resource is mapped is different.

11. The method of claim 10, wherein performing resource exclusion on the first resource set to determine one resource set comprises:
performing resource exclusion on the first resource set to determine one third resource set, wherein the third resource set comprises N1 fourth resource sets; and
wherein reporting the determined resource set to the first communication entity comprises:
reporting the determined third resource set to the first communication entity;
wherein one fourth resource set corresponds to one resource mapping mode, and in different resource mapping modes, a number of first frequency domain units to which one resource is mapped is different.

12. The method of claim 10, wherein separately performing resource exclusion on the N second resource sets to determine the N resource sets comprises:
separately performing resource exclusion on each resource set in the N second resource sets to determine one fifth resource set for each resource set; and
wherein reporting the determined resource set to the first communication entity comprises:
reporting the determined N fifth resource sets to the first communication entity;
wherein one fifth resource set corresponds to one resource mapping mode, and in different resource mapping modes, a number of first frequency domain units to which one resource is mapped is different.

13. The method of claim 10, wherein the assistance information comprises at least one resource mapping mode; determining the resource set based on the assistance information at least comprises one of the following:
determining a first resource set and a second resource set based on the at least one resource mapping mode;
determining a first resource set based on the at least one resource mapping mode; or
determining a second resource set based on the at least one resource mapping mode.

14. The method of claim 12, further comprising:
sending first signaling information to the first communication entity, wherein the first signaling information is used for indicating a resource mapping mode corresponding to each of the N fifth resource sets.

15. The method of claim 11, further comprising:
sending second signaling information to the first communication entity, wherein the second signaling information is used for indicating a resource mapping mode corresponding to each resource in each third resource set.

16. The method of claim 11, wherein the third resource set comprises a plurality of resources; reporting the determined third resource set to the first communication entity comprises:
sorting the plurality of resources according to a number of first frequency domain units corresponding to a resource mapping mode; and
reporting the sorted third resource set to the first communication entity,
wherein sorting the plurality of resources according to the number of first frequency domain units corresponding to the resource mapping mode comprises one of the following:
sorting the plurality of resources according to the number of first frequency domain units corresponding to the resource mapping mode in ascending order; or
sorting the plurality of resources according to the number of first frequency domain units corresponding to the resource mapping mode in descending order.

17. The method of claim 12, further comprising:
sending third signaling information to the first communication entity, wherein the third signaling information comprises the determined N fifth resource sets;
wherein sending the third signaling information to the first communication entity comprises:
sorting the N fifth resource sets in the third signaling information according to a number of first frequency domain units corresponding to a resource mapping mode; and
reporting the sorted third signaling information to the first communication entity,
wherein sorting the N fifth resource sets according to the number of first frequency domain units corresponding to the resource mapping mode comprises one of the following:
sorting the N fifth resource sets according to the number of first frequency domain units corresponding to the resource mapping mode in ascending order; or
sorting the N fifth resource sets according to the number of first frequency domain units corresponding to the resource mapping mode in descending order.

18-19. (canceled)

20. The method of claim 12, further comprising:
receiving a radio resource control (RRC) message sent by a third communication entity, wherein the RRC message comprises proportional value configuration information corresponding to each of the N second resource sets, and a proportional value corresponding to a second resource set i is labeled as Xᵢ; and
determining a reference signal received power (RSRP) threshold value Tᵢ corresponding to the second resource set i;
wherein the RSRP threshold value Tᵢ meets a condition that a value of Nᵢ is greater than or equal to a product value of Xᵢ and Mᵢ;
wherein separately performing resource exclusion on the N second resource sets comprises:
separately performing resource exclusion on the N second resource sets based on an RSRP threshold value Tᵢ corresponding to each of the N second resource sets, wherein Nᵢ is a number of remaining resources after resource exclusion is performed on the second resource set i, Mᵢ is a total number of resources comprised in the second resource set i, and i is a positive integer greater than or equal to 1 and less than or equal to N,
wherein the RRC message further comprises a relationship between a channel busy ratio (CBR) range and a proportional value Xᵢ, and the relationship between the CBR range and the proportional value Xᵢ is used for determining a proportional value Xᵢ corresponding to each of the N second resource sets.

21. (canceled)

22. The method of claim 1, further comprising:
receiving a resource set reported by a second communication entity, wherein each resource in the resource set comprises L second frequency domain units; and
selecting at least one resource from the resource set to cause a user equipment corresponding to the first communication entity to send communication information using the selected at least one resource.

23-30. (canceled)

31. A communication entity, comprising a memory and at least one processor; wherein
the memory is configured to store at least one program; and
when the at least one program is executed by the at least one processor, the at least one processor is caused to implement the method of claim 1.

32. A non-transitory storage medium storing a computer program which, when executed by a processor, causes the processor to implement the method of claim 1.
